(19) United States
(12) Patent Application Publication
(10) Pub. No.: US 2010/0123944 A1
(43) Pub. Date: May 20, 2010

(54) REPRODUCTION APPARATUS AND REPRODUCTION METHOD

(75) Inventor: Terumasa ITO, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION, Tokyo (JP)

(21) Appl. No.: 12/605,143

(22) Filed: Oct. 23, 2009

(30) Foreign Application Priority Data
Nov. 20, 2008 (JP) 2008-296570
Jan. 19, 2009 (JP) 2009-008845

(51) Int. Cl. G03H 1/12

(52) U.S. Cl. 359/11

(57) ABSTRACT

A reproduction apparatus includes: a wavelength-tunable light source that outputs light illuminating a hologram recording medium such that a wavelength is variable; an optical system that illuminates through an objective lens the hologram recording medium with the reference light generated on the basis of light emitted from the wavelength-tunable light source and that includes a power changing section which changes a zoom power of the reference light incident on the objective lens; a temperature detecting section that detects a temperature of the hologram recording medium; and a control section that, when setting the zoom power of the reference light and the wavelength of the wavelength-tunable light source in response to a result of the temperature detected by the temperature detecting section, performs control such that the zoom power of the reference light and the wavelength of the wavelength-tunable light source satisfy a condition

$$[ Δ m = \frac{Δ λ}{{λ}_{W}} ] .$$

### BACKGROUND OF THE INVENTION

1. Field of the Invention

The present invention relates to a reproduction apparatus and a reproduction method of performing reproduction on a hologram recording medium in which information is recorded by forming a hologram using interference fringes between signal light and reference light.

2. Description of the Related Art

For example, as disclosed in Japanese Unexamined Patent Application Publication No. 2007-200385, a hologram recording/reproduction method of performing data recording by forming a hologram by interference fringes between signal light and reference light beam is known. In this hologram recording/reproduction method, at the time of recording, signal light subjected to spatial light modulation (for example, light intensity modulation) corresponding to recording data and reference light different from the signal light illuminate a hologram recording medium and interference fringes (hologram) between the signal light and the reference light are formed in the recording medium to thereby perform the data recording.

Moreover, at the time of reproduction, the reference light illuminates the recording medium. By the illumination of the reference light, diffracted light corresponding to the interference fringes formed as described above is obtained. That is, a reproduced image (reproduced signal light) corresponding to the recording data is obtained as described above. The recording data is reproduced by detecting the reproduced image obtained as described above with an image sensor, such as a CCD (Charge Coupled Device) sensor or a CMOS (Complementary Metal Oxide Semiconductor) sensor.

FIGS. 22, 23A, and 23B are diagrams for illustrating a hologram recording/reproduction method. FIG. 22 schematically shows the recording method, and FIGS. 23A and 23B schematically show the reproduction method.

FIGS. 22, 23A, and 23B show the recording/reproduction method when a so-called coaxial method of performing recording by disposing signal light and reference light on the same optical axis is adopted.

Moreover, FIGS. 22, 23A, and 23B show the case where a reflective hologram recording medium 100 with a reflective film is used.

First, as shown in FIGS. 22, 23A, and 23B, in the hologram recording/reproduction using the coaxial method, a SLM (spatial light modulator) 101 for generating signal light and reference light on the same optical axis is provided. As the SLM 101, an intensity modulator that performs spatial light intensity modulation (referred to as light intensity modulation or simply referred to as intensity modulation) on the incident light in the pixel unit is provided. As the intensity modulator, for example, a liquid crystal panel may be used.

First, at the time of recording shown in FIG. 22, signal light with an intensity pattern corresponding to the recording data and reference light with a predetermined intensity pattern set beforehand are generated by intensity modulation of the SLM 101. Typically, in the coaxial method, the signal light is disposed at the inner side and the reference light is disposed at the outer side as shown in FIG. 22.

The signal light and the reference light generated by the SLM 101 illuminates the hologram recording medium 100 through an objective lens 102. As a result, a hologram which reflects the recording data is formed in the hologram recording medium 100 by the interference fringes between the signal light and the reference light. That is, recording of data is performed by the forming of the hologram.

On the other hand, at the time of reproduction, reference light is generated by the SLM 101 as shown in FIG. 23A (in this case, the intensity pattern of the reference light is the same as that at the time of recording). In addition, the reference light illuminates the hologram recording medium 100 through the objective lens 102.

By the illumination of the reference light onto the hologram recording medium 100, diffracted light corresponding to the hologram formed in the hologram recording medium 100 is obtained and accordingly, a reproduced image based on the recorded data is obtained as shown in FIG. 23B. In this case, the reproduced image is guided, as light reflected from the hologram recording medium 100, to an image sensor 103 through the objective lens 100 as shown in FIG. 23B.

The image sensor 103 obtains a detection image regarding the reproduced image by receiving the reproduced image guided as described above in the pixel unit and acquiring an electric signal corresponding to the amount of received light for every pixel. The image signal detected as described above by the image sensor 103 becomes a read signal of the recorded data.

Moreover, as can also be understood from the explanation of FIGS. 22, 23A, and 23B, the recording data is recorded/reproduced in the unit of signal light in the hologram recording/reproduction method. That is, in the hologram recording/reproduction method, one hologram (called a hologram page) which is formed by one-time interference between signal light and reference light is set as the smallest unit of recording/reproduction.

Here, at the time of hologram recording, a change in the temperature of the media occurs due to the illumination of the recording light and the like. As a result, a volume change or refractive index change occurs in a hologram recording material represented by a photopolymer, for example. In particular, regarding the volume change, if a hologram is formed under the conditions in which a recording material has expanded due to the temperature rise at the time of recording, the formed hologram also contracts accordingly when the recording material contracts after recording. As described above, at the time of reproduction, the hologram is reproduced by illumination of the same reference light as when the recording was performed. For this reason, if the hologram contracts as described above compared with the hologram at the time of recording, changes occur in the relationship between the incidence angles of signal light and reference light at the time of recording and the relationship between the angle of the hologram (hologram in which the signal light is recorded) and the incidence angle of the reference light at the time of reproduction. Accordingly, the diffraction efficiency is reduced, and it becomes extremely difficult to obtain a sufficient amount of reproduced signal light. As a result, the SN ratio (S/N) drops significantly.

Thus, in the hologram recording/reproduction method, the temperature change in the media at the time of recording and reproduction has a large influence on the SN ratio. Accordingly, in order to realize an appropriate recording/reproduction operation, there is a demand to compensate for the reduction in the diffraction efficiency caused by the temperature change described above.

Regarding temperature compensation in such a hologram recording/reproduction method, various methods have been proposed, for example, in Japanese Unexamined Patent Application Publication Nos. 2006-349831, 2007-200394, and 2007-240820.

Japanese Unexamined Patent Application Publication Nos. 2006-349831, 2007-200394, and 2007-240820 propose 1) a method of shifting the wavelength of the reference light, which illuminates a recording medium at the time of reproduction, from the set recording wavelength in response to the temperature variation from the recording point of time, 2) a method of changing the distribution of the reference light incidence angle by changing the zoom power of the reference light at the time of reproduction in response to the temperature variation from the recording point of time, and 3) a method of changing both the zoom power and wavelength of the reference light in response to the temperature variation from the recording point of time (corresponding to a combination of the methods 1) and 2)).

Thus, by changing the incidence angle distribution or the wavelength of the reference light in response to the temperature variation from the recording point of time, the reduction in the diffraction efficiency caused by the temperature change can be effectively compensated.

Moreover, the point that the diffraction efficiency can be improved by changing the wavelength or incidence angle of the reference light as described above can be understood when the following point is taken into consideration. That is, the terms of the wavelength λ and incidence angle sin θ of light incident on a diffraction grating are included in Bragg's diffraction condition (Bragg's condition) 2d sin θ=nλ, which is based on the so-called Bragg's law.

### SUMMARY OF THE INVENTION

For example, as disclosed in Japanese Unexamined Patent Application Publication No. 2006-349831 or 2007-240820, in order to improve the diffraction efficiency, it is more effective to change both the wavelength and the zoom power of the reference light rather than to change only the wavelength or the zoom power of the reference light.

This applicant experimented on the method of changing both the wavelength of reference light and the zoom power of reference light in order to effectively improve the SN ratio. In the experiment, the combination of the values of the wavelength and zoom power to be set in response to the temperature variation was adjusted so that the diffraction efficiency could be improved to the maximum extent.

However, as a result of the experiment, effective improvement in S/N ratio was not achieved.

This applicant performed further experiments and numerical analyses. As a result, this applicant found out that the reason that the SN ratio was not improved as described above was an image blur in the reproduced image.

Here, this applicant proceeded with an experiment regarding the hologram recording/reproduction system using the coaxial method. However, when the coaxial method is adopted, each light beam (light beam for each pixel) within the reference light illuminates one point of signal light that carries 1-bit information (light for one pixel) at different angle so that a hologram is formed by the interference fringes, unlike the case of a so-called two beam method (angle multiplexing method) in which illumination of reference light is performed with an optical axis different from that of the signal light. In other words, a reproduced image of one pixel is a superposition of diffracted light beams diffracted by many diffraction grating vectors. Accordingly, in the coaxial method, when the incidence condition of reference light at the time of reproduction changes from the condition at the time of recording, a phenomenon may arise in which the emission angles of diffracted signal light beams for one pixel diffracted by the many diffraction grating vectors may vary. As a result, the diffracted signal light beams may not appropriately focus at one pixel position, and this results in an image blur in the reproduced image.

Since this image blur serves as a crosstalk component to other bits (pixels), the SN ratio drops significantly as a result.

Due to the occurrence of the image blur of the reproduced images, even if the temperature compensation is performed by adjusting the wavelength or zoom power of the reference light so that the diffraction efficiency is improved to the maximum extent as described above, the SN ratio is not effectively improved as a result.

That is, as can also be understood from this point, in the temperature compensation using the coaxial method, it is important not only to improve the diffraction efficiency but also to effectively prevent a blur in the reproduced image in order to improve the S/N ratio.

In view of the above, it is desirable to effectively improve the SN ratio (S/N) by preventing blurring in the reproduced image in the case where a technique is adopted of compensating for a reduction in the diffraction efficiency, which is caused by temperature change, by adjustment of the zoom power (incidence angle) or wavelength of the reference light.

According to an embodiment of the present invention, a light illuminating device is configured as follows.

That is, the light illuminating device includes a wavelength-tunable light source that outputs light, which illuminates a hologram recording medium in which information is recorded by forming a hologram using interference fringes between signal light and reference light, such that a wavelength is variable.

In addition, the light illuminating device includes an optical system that illuminates through an objective lens the hologram recording medium with the reference light generated on the basis of light emitted from the wavelength-tunable light source and that includes a power changing section which changes a zoom power of the reference light incident on the objective lens.

In addition, the light illuminating device includes a temperature detecting section that detects a temperature of the hologram recording medium.

In addition, the light illuminating device includes a control section that, when setting the zoom power of the reference light and the wavelength of the wavelength-tunable light source in response to a result of the temperature detected by the temperature detecting section, performs control such that the zoom power of the reference light and the wavelength of the wavelength-tunable light source satisfy a condition of

$$Δ m = \frac{Δ λ}{{λ}_{W}}$$

where, λ_{W} is a recording wavelength, Δm is a zoom power variation of the reference light from a recording point of time, and Δλ is a wavelength variation of the wavelength-tunable light source with respect to the recording wavelength.

According to the embodiment of the present invention, the zoom power and wavelength of the reference light, which satisfy the condition of the above formula, are set and the reproduction is performed. Accordingly, as will be apparent from subsequent explanations, an image blur in the reproduced image can be prevented in the case where only a volume change in the vertical direction (direction orthogonal to the in-recording-surface direction) is preferably taken into consideration since the volume change of the recording material in the in-recording-surface direction caused by the temperature change is so small as to be negligible.

Furthermore, according to another embodiment of the present invention, a reproduction apparatus is configured as follows.

That is, the reproduction apparatus includes a wavelength-tunable light source that outputs light, which illuminates a hologram recording medium in which information is recorded by forming a hologram using interference fringes between signal light and reference light, such that a wavelength is variable.

In addition, the reproduction apparatus includes an optical system that illuminates through an objective lens the hologram recording medium with the reference light generated on the basis of light emitted from the wavelength-tunable light source and that includes a power changing section which changes a zoom power of the reference light incident on the objective lens.

In addition, the reproduction apparatus includes a temperature detecting section that detects a temperature of the hologram recording medium.

In addition, the reproduction apparatus includes a control section that when setting the zoom power of the reference light and the wavelength of the wavelength-tunable light source in response to a result of the temperature detected by the temperature detecting section, performs control such that the zoom power of the reference light and the wavelength of the wavelength-tunable light source satisfy a condition of

$$1 + Δ m = \frac{1}{( 1 + {C}_{TEX} Δ T + {σ}_{X} )} ( 1 + \frac{Δ λ}{{λ}_{W}} )$$

where, λ_{W} is a recording wavelength, λm is a zoom power variation of the reference light from a recording point of time, Δλ is a wavelength variation of the wavelength-tunable light source with respect to the recording wavelength, σ_{X} is a recording material contraction rate in an in-recording-surface direction according to the polymerization of a monomer of a recording material of the hologram recording medium, C_{TEX} is a coefficient of linear expansion of the recording material, and ΔT is a temperature variation from a recording point of time.

According to the embodiment of the present invention, the zoom power and wavelength of the reference light, which satisfy the condition of the above formula, are set and the reproduction is performed. As will be apparent from subsequent explanations, according to the embodiment of the present invention, an image blur in the reproduced image can be prevented in the case where the volume change of the recording material caused by the temperature change occurs not only in the vertical direction but also in the in-recording-surface direction.

According to the embodiments of the present invention, when a method of compensating a reduction in diffraction efficiency, which is caused by temperature change, by changing the zoom power and wavelength of the reference light is adopted, occurrence of an image blur in the reproduced image can be prevented. Accordingly, the SN ratio can be improved in terms of both an improvement in diffraction efficiency and the prevention of image blur. As a result, the operable temperature range of the hologram recording/reproduction system can be enlarged.

### BRIEF DESCRIPTION OF THE DRAWINGS

FIG. 1 is a block diagram showing the internal configuration of a recording/reproduction apparatus according to a first embodiment;

FIG. 2 is a diagram showing the sectional structure of a hologram recording medium used in the embodiment;

FIG. 3 is a diagram illustrating a signal light area, a reference light area, and a gap area which are set in an SLM (spatial light modulator);

FIG. 4 is a diagram showing an example of the data structure of an adjustment value table;

FIGS. 5A and 5B are diagrams illustrating a zoom power adjusting section;

FIG. 6 is a diagram illustrating the zoom power adjustment of reference light using spatial light modulation of the SLM;

FIGS. 7A and 7B are diagrams schematically showing the states of light beams illuminating a hologram recording medium at the time of enlargement/reduction of reference light;

FIGS. 8A and 8B are diagrams schematically showing the states where the media temperature at the time of reproduction has changed from the temperature at the time of recording;

FIG. 9 is a diagram illustrating the relationship between a wave vector and a diffraction grating vector in the hologram recording process;

FIGS. 10A and 10B are diagrams showing the selectivity of the Bragg diffraction on the K space;

FIG. 11 is a diagram schematically showing the state where a hologram expands with a rise in temperature and a grating vector is reduced with the expansion;

FIG. 12 is a diagram showing on the K space the Bragg mismatch, which occurs when only the average refractive index of a recording material is reduced after hologram recording;

FIG. 13 is a diagram showing the state at the time of reproduction of a hologram on the K space;

FIG. 14 is a diagram schematically showing the relationship among reference light (and the reference light area), a grating vector, and diffracted signal light (and the signal light area) on the K space at the time of normal reproduction (when there is no image blur);

FIG. 15 is a diagram schematically showing the relationship among reference light (and the reference light area), a grating vector, and diffracted signal light (and the signal light area) on the K space when the emission angle of the diffracted signal light deviates (when there is an image blur);

FIG. 16 is a diagram showing on the K space a temperature-compensated image, in which an image blur is prevented;

FIG. 17 is a diagram showing a calculation result regarding diffraction efficiency−temperature variation characteristic at the time of temperature compensation when the temperature variation ΔT is +5° C.;

FIG. 18 is a diagram showing an experimental result regarding a change characteristic of the diffraction efficiency to a temperature change;

FIG. 19 is a flow chart showing the processing procedures at the time of recording which are to be performed in order to realize a temperature compensation method of the embodiment;

FIG. 20 is a flow chart showing the processing procedures at the time of reproduction which are to be performed in order to realize a temperature compensation method of the embodiment;

FIG. 21 is a block diagram showing the internal configuration of a recording/reproduction apparatus according to a second embodiment;

FIG. 22 is a diagram illustrating a hologram recording/reproduction method (at the time of recording) based on a coaxial method; and

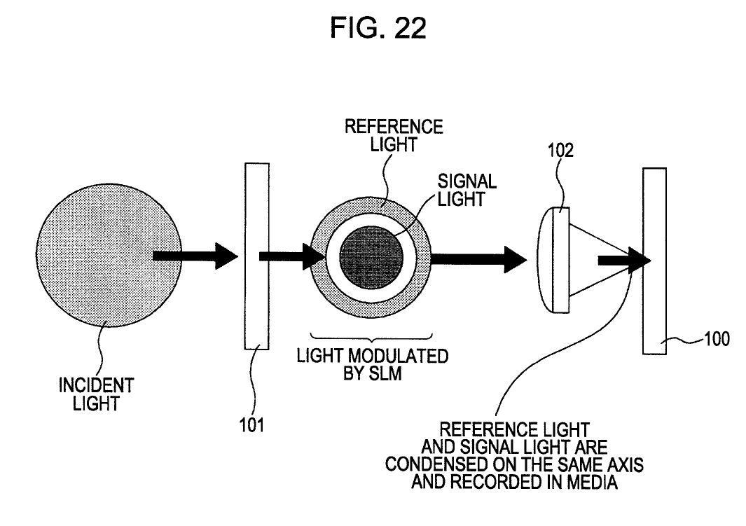

FIGS. 23A and 23B are diagrams illustrating a hologram recording/reproduction method (at the time of reproduction) based on the coaxial method.

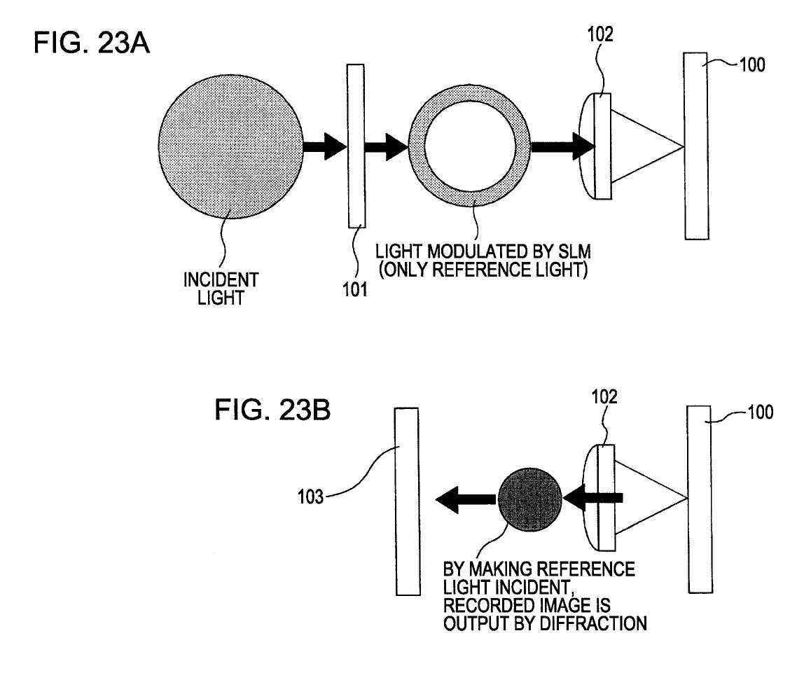

### DESCRIPTION OF THE PREFERRED EMBODIMENTS

Hereinafter, best modes (hereinafter, referred to as embodiments) for carrying out the present invention will be described.

In addition, the explanation is made in following order.

<First Embodiment>

[1. Configuration of a Hologram Recording/Reproduction System]

[2. Derivation of Conditional Expression for Prevention of Image Blur]

<2-1. Outline of Explanation>

<2-2. Temperature Dependency of Hologram Media>

(2-2-1. Change of Physical Properties in Response to Temperature Change)

(2-2-2. Reduction in Diffraction Efficiency by Bragg Mismatching)

(2-2-3. Maximization and Equalization of Page Diffraction Efficiency)

(2-2-4. Image Blur in a Coaxial Method)

<2-3. Derivation of Conditional Expression Based on Theoretical Analysis>

[3. Derivation of Reproduction Condition for Improvement and Equalization of Diffraction Efficiency]

[4. Temperature-Compensated Image in which Image Blur is Prevented]

[5. Method of Determining Zoom Power and Wavelength for Realizing Temperature Compensation in which Image Blur is Prevented]

[6. Simulation and Experiment Results]

[7. Specific Example of Temperature Compensation Processing in an Embodiment]

[8. Conclusion]

<Second Embodiment>

<Modifications>

### First Embodiment

### 1. Configuration of a Hologram Recording/Reproduction System

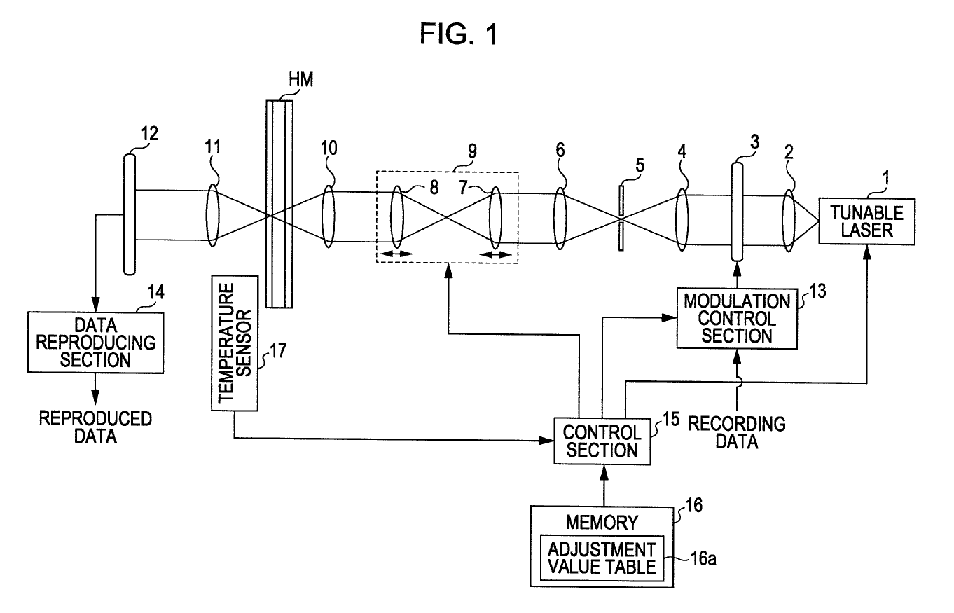

FIG. 1 is a block diagram showing the internal configuration of a recording/reproduction apparatus according to an embodiment of the present invention.

The recording/reproduction apparatus shown in FIG. 1 is configured to perform recording and reproduction of a hologram using a coaxial method. In the coaxial method, signal light and reference light are disposed on the same optical axis, and illuminate a hologram recording medium set at the predetermined position so that the data is recorded by forming a hologram, or the reference light illuminates the hologram recording medium at the time of reproduction so that the data recorded as the hologram is reproduced.

In addition, the recording/reproduction apparatus shown in FIG. 1 is configured to perform recording/reproduction corresponding to a transmissive hologram recording medium HM which does not have a reflective film.

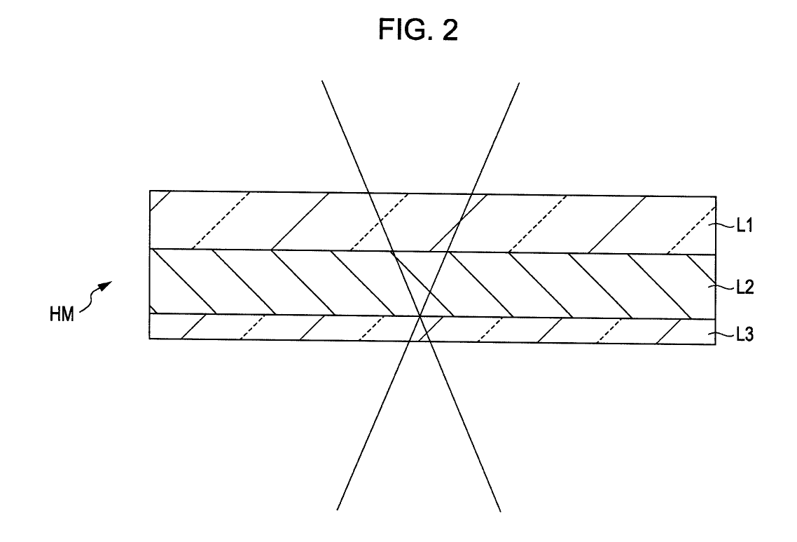

Here, the sectional structure of the hologram recording medium HM will be described with reference to FIG. 2.

As shown in FIG. 2, a cover layer L1, a recording layer L2, and a substrate L3 are formed in the hologram recording medium HM in order from the upper layer side to the lower layer side.

Moreover, for clarity, assuming that a surface on which light for recording/reproduction is incident is an upper surface and a surface located at the opposite side of the upper surface is a lower surface, the “upper layer” and “lower layer” referred to herein correspond to the upper surface side and the lower surface side, respectively.

The cover layer L1 is formed of a transparent resin, such as glass or polycarbonate, and is provided to protect the recording layer L2. As a material of the recording layer L2, a recording material (so-called hologram recording material) whose refractive index changes due to the polymerization of a monomer by the illumination of light so that a hologram corresponding to the intensity distribution of the illuminating light is formed, for example, photopolymer, is selected.

In addition, the substrate L3 is a transparent substrate formed of polycarbonate or glass, for example.

In addition, the structure of the hologram recording medium HM shown in FIG. 2 is only an example, and the present invention is not limited thereto. For example, a necessary configuration may be appropriately added according to an actual embodiment, like providing an AR (Anti Reflection) coat layer on an upper layer of the cover layer L1.

This explanation continues referring back to FIG. 1.

First, in the recording/reproduction apparatus in this case, a tunable laser 1 is provided as a light source for recording/reproduction of a hologram.

As the tunable laser 1, a laser is used having a configuration where the wavelength of output light is changed by rotating a set of a polarization beam splitter and a diffraction grating for guiding the emitted light from a laser diode while maintaining the positional relationship, for example, like the tunable laser light source disclosed in Japanese Unexamined Patent Application Publication No. 2007-240820. In this case, the center wavelength (wavelength of the laser diode) of the laser light is about 405 nm, and the wavelength can be changed within the range of about 5 to 10 nm from the center wavelength by the wavelength tunable mechanism.

Control of setting the wavelength of the tunable laser 1 is performed by a control section 15, which will be described later.

In addition, the configuration of the tunable laser 1 is not limited to that illustrated above, and it is a matter of course that configurations which change the wavelength by other methods can be adopted.

The emitted light from the tunable laser 1 becomes parallel light through a collimation lens 2 and is then incident on a SLM (spatial light modulator) 3.

The SLM 3 is formed by a transmissive liquid crystal panel, for example, and performs spatial light intensity modulation (also simply referred to as intensity modulation) on the incident light in the pixel unit in response to a driving signal from a modulation control section 13 in FIG. 1.

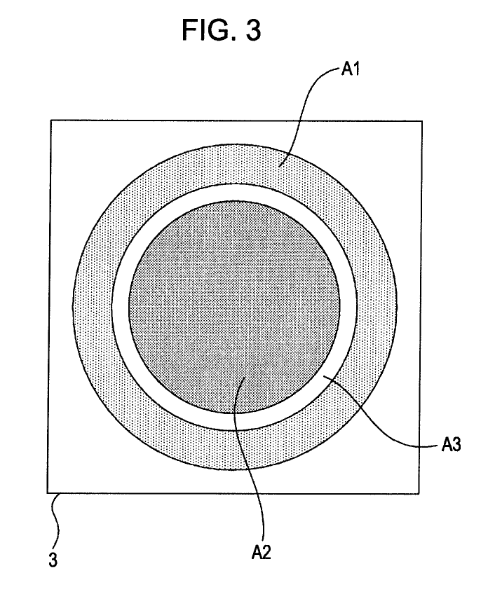

In the present embodiment, the coaxial method is adopted as a hologram recording/reproduction method. When the coaxial method is adopted, each area shown in FIG. 3 is set in the SLM 3 in order to dispose signal light and reference light on the same optical axis.

As shown in FIG. 3, in the SLM 3, the area within a predetermined circular range including the center (matched with the optical axis of laser light) is set as a signal light area A2. In addition, a ring-shaped reference light area A1 is set in the outside of the signal light area A2 with a gap area A3 interposed therebetween.

By setting the signal light area A2 and the reference light area A1, the signal light and the reference light can be disposed on the same optical axis to perform illumination.

The gap area A3 is set as a region for preventing the reference light generated in the reference light area A1 from leaking into the signal light area A2 and becoming signal light noise.

For clarity, the signal light area A2 is not circular in the strict sense because the pixel shape of the SLM 3 is rectangular. Similarly, the reference light area A1 and the gap area A3 do not have a ring shape in the strict sense. Regarding these meanings, the signal light area A2 has an approximately circular shape, and each of the reference light area A1 and the gap area A3 has an approximately ring shape.

Referring back to FIG. 1, the modulation control section 13 performs driving control of the SLM 3 so that signal light and reference light are generated at the time of recording and the reference light is generated at the time of reproduction.

Specifically, at the time of recording, the modulation control section 13 generates a driving signal which makes pixels in the signal light area A2 of the SLM 3 have an ON/OFF pattern corresponding to the supplied recording data, makes the pixels in the reference light area A1 have a predetermined ON/OFF pattern set beforehand, turns off the other pixels, and supplies the driving signal to the SLM 3. By performing the intensity modulation on the basis of the driving signal by the SLM 3, signal light and reference light which are disposed around the optical axis of laser light are obtained as the emitted light from the SLM 3.

Moreover, at the time of reproduction, the modulation control section 13 controls the driving of the SLM 3 by a driving signal, which makes the pixels in the reference light area A1 have a predetermined ON/OFF pattern and turns off the other pixels. As a result, only the reference light is obtained as the emitted light from the SLM 3.

In addition, at the time of recording, the modulation control section 13 operates such that an ON/OFF pattern within the signal light area is generated for every predetermined unit of the input recording data stream and accordingly, signal light in which the data is stored for every predetermined unit of the recording data stream is generated in a sequential manner. Thus, the data is sequentially recorded in the hologram recording medium HM in the hologram page unit (data unit recordable by one-time interference between the signal light and the reference light).

In addition, the operation of the modulation control section 13 is controlled by the control section 15.

The laser light emitted from the SLM 3 is guided to a relay lens system in which a relay lens 4, an aperture 5, and a relay lens 6 are disposed in the order shown in FIG. 1. As shown in FIG. 1, the relay lens 4 makes the laser light from the SLM 3 condensed at the predetermined focal position, and the relay lens 6 converts the laser light as diffused light after the condensing into parallel light. The aperture 5 is provided at the focal position (Fourier surface: frequency flat surface) generated by the relay lens 4 and is configured to allow only light within the predetermined range around the optical axis to pass therethrough and to block the other light. The size of a hologram page recorded in the hologram recording medium HM is restricted by the aperture 5, so that the recording density (that is, data recording density) of a hologram can be improved.

The laser light transmitted through the relay lens system is incident on a zoom power adjusting section 9 in which lenses 7 and 8 are disposed in this order as shown in FIG. 1. The lens 7 makes the laser light incident from the relay lens system condensed at the necessary focal position, and the lens 8 converts the laser light as diffused light after the condensing into parallel light.

The zoom power adjusting section 9 is configured to enlarge/reduce the size (diameter) of incident light on the basis of the control of the control section 15, which will be described later.

The laser light transmitted through the zoom power adjusting section 9 illuminates the hologram recording medium HM through an objective lens 10.

In this case, the focal point formed by the objective lens 10 is controlled to be located at the interface between the recording layer L2 and the substrate L3 in the hologram recording medium HM. Although not shown, a configuration for focus servo control of the objective lens 10 is provided in the recording/reproduction apparatus shown in FIG. 1. The focus servo control may be performed using various methods adopted in current optical disk systems, such as a CD (Compact Disc) or a DVD (Digital Versatile Disc).

Here, at the time of recording, signal light subjected to light intensity modulation according to the recording data and reference light with the predetermined intensity pattern are generated on the basis of the control of the modulation control section 13. The signal light and the reference light generated as described above illuminate the hologram recording medium HM through the objective lens 10 along the optical path. As a result, a hologram which reflects the recording data is formed in the recording layer L2 of the hologram recording medium HM by the interference fringes between the signal light and the reference light. That is, the recording of data is performed.

Moreover, for clarity, in the coaxial method, the recording layer L2 is formed to be sufficiently thick for the recording wavelength so that volume hologram recording is performed. A so-called thick hologram is recorded.

On the other hand, at the time of reproduction, only the reference light is generated as described above and the reference light illuminates the hologram recording medium HM (recording layer L2) through the objective lens 10 along the optical path. By the illumination of the reference light, diffracted light corresponding to the hologram formed in the recording layer L2 is obtained. That is, a reproduced image (reproduced light) corresponding to the data recorded in the hologram recording medium HM is obtained.

The reproduced light obtained by the illumination of the reference light as described above is transmitted through the hologram recording medium HM and is then incident on a condensing lens 11 as diffused light as shown in FIG. 1. The reproduced light becomes parallel light by the condensing lens 11 and is then incident on an image sensor 12 as shown in FIG. 1.

The image sensor 12 includes an imaging device, such as a CCD (Charge Coupled Device) sensor or a CMOS (Complementary Metal Oxide Semiconductor) sensor, receives the reproduced light from the hologram recording medium HM which is incident (imaged) as described above, and converts the reproduced light into an electric signal to thereby acquire an image signal. The image signal obtained as described above reflects the ON/OFF pattern (that is, a data pattern of “0” and “1”) of the signal light at the time of recording. That is, the image signal detected as described above by the image sensor 12 is equivalent to a read signal of the data recorded in the hologram recording medium HM.

A data reproducing section 14 reproduces the recording data by performing data identification of “0” and “1” for every value in the pixel unit of the SLM 3, which is included in the image signal detected by the image sensor 12, and performing demodulation processing of a recording modulation code and the like when necessary. That is, the reproduced data is obtained.

In addition, the control section 15 for performing overall control of the recording/reproduction apparatus is provided in the recording/reproduction apparatus shown in FIG. 1.

For example, the control section 15 is a microcomputer including a CPU (Central Processing Unit), a ROM (Read Only Memory), a RAM (Random Access Memory), and the like. The control section 15 performs overall control of the recording/reproduction apparatus by executing various kinds of calculation processing and control processing according to a program stored in the ROM, for example.

A memory 16 and a temperature sensor 17 are connected to the control section 15 as shown in FIG. 1.

The temperature sensor 17 detects the temperature of the hologram recording medium HM loaded in the recording/reproduction apparatus. For example, the temperature sensor 17 has a configuration in which a thermistor, which detects the temperature as a resistance value, is disposed in a portion positioned close to the loaded hologram recording medium HM.

In addition to the configuration including such a thermistor, other configurations may also be adopted as the temperature sensor 17. For example, a temperature detector based on the thermography which is commercially available may be used.

In the memory 16, an adjustment value table 16a is stored as shown in FIG. 1.

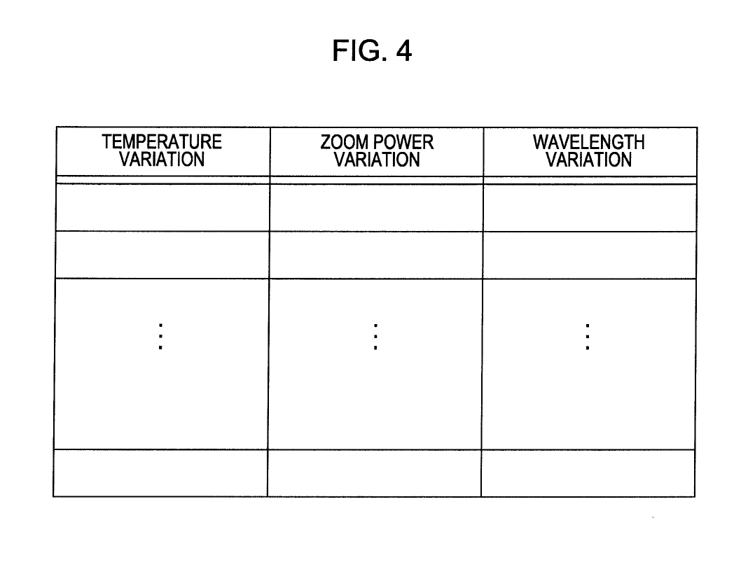

FIG. 4 shows an example of the data structure of the adjustment value table 16a.

As shown in FIG. 4, a set of a zoom power variation value and a wavelength variation value which are to be set in response to the temperature variation are stored in the adjustment value table 16a for every value of the temperature variation.

The control section 15 performs control of a lens driving section 9 (or modulation control section 13) and control of the tunable laser 1 such that at the time of reproduction, the reference light zoom power and the wavelength are adjusted in response to the temperature variation (ΔT) from the recording point of time on the basis of a temperature detection result of the hologram recording medium HM by the temperature sensor 17 and the information of the adjustment value table 16a. That is, the control processing for temperature compensation is executed.

In addition, details of the specific temperature compensation processing as an embodiment realized by the control section 15 and details of the values to be stored in the adjustment value table 16a will be described later.

˜Regarding the Adjustment of Zoom Power˜

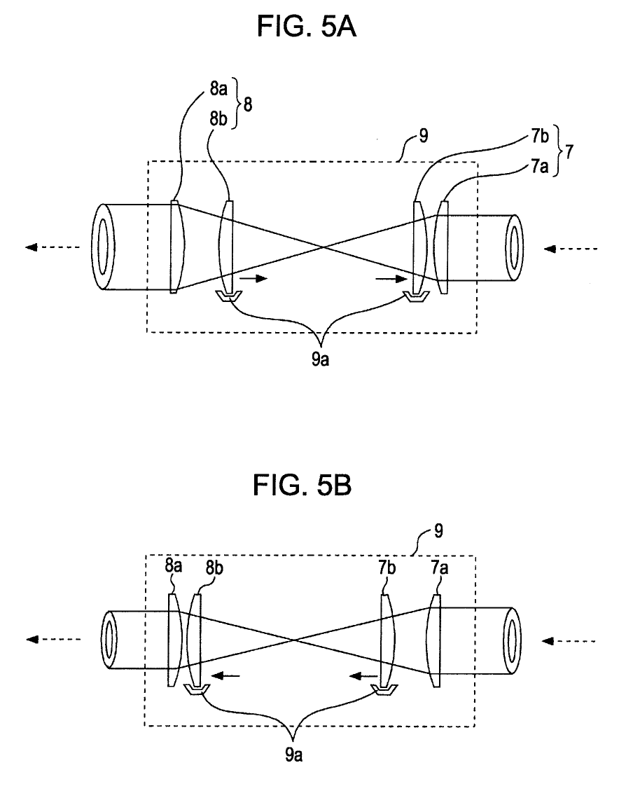

FIGS. 5A and 5B show the internal configuration of the zoom power adjusting section 9 shown in FIG. 1. FIG. 5A shows the state when laser light is enlarged, FIG. 5B shows the state when laser light is reduced.

As shown in FIGS. 5A and 5B, a set of fixed lens 7a and movable lens 7b, which form the lens 7 shown in FIG. 1, and a set of fixed lens 8a and movable lens 8b, which form the lens 8 shown in FIG. 1, are provided in the zoom power adjusting section 9. In addition, a lens driving section 9a which drives the movable lens 7b and the movable lens 8b in a direction parallel to the optical axis of laser light is provided.

Although the detailed configuration of the lens driving section 9a is not shown for convenience of illustration, the lens driving section 9a has a lens driving mechanism, which holds the movable lens 7b and the movable lens 8b so as to be able to move in the direction parallel to the optical axis of laser light, and a driving section that gives to the lens driving mechanism a driving force for moving the movable lens 7b and the movable lens 8b, for example, using a motor. By making the driving section give the driving force to the lens driving mechanism on the basis of the control of the control section 15 shown in FIG. 1, the movable lens 7b and the movable lens 8b are driven in the direction according to the control of the control section 15 and by the amount of driving according to the control of the control section 15.

Specifically, at the time of enlargement shown in FIG. 5A, the lens driving section 9a drives the movable lens 7b and the movable lens 8b to the light source side (side becoming distant from the hologram recording medium HM) according to the control of the control section 15. As a result, as shown in FIG. 5A, the size of the emitted light is enlarged compared with the size (in this case, the diameter) of the incident light.

On the other hand, at the time of reduction shown in FIG. 5B, the lens driving section 9a drives the movable lens 7b and the movable lens 8b to the opposite side (side becoming close to the hologram recording medium HM) to the side at the time of enlargement according to the control of the control section 15. As a result, the size of the emitted light is reduced compared with the size of the incident light.

In this way, the zoom power adjusting section 9 is configured to be able to change the power (also called the zoom power) of the size of the incident laser light.

As can also be understood from the above explanation, the control of setting the zoom power regarding the zoom power adjusting section 9 is performed by the control section 15. Specifically, the control of setting the zoom power is performed when the control section 15 controls the driving direction and driving amount of the movable lenses 7b and 8b using the lens driving section 9a in response to the value of reference light zoom power variation (Δm), which will be described later.

Here, adjustment of the zoom power of reference light may be performed by the zoom power adjusting section 9 or may be performed by changing the size of the reference light generated by the SLM 3.

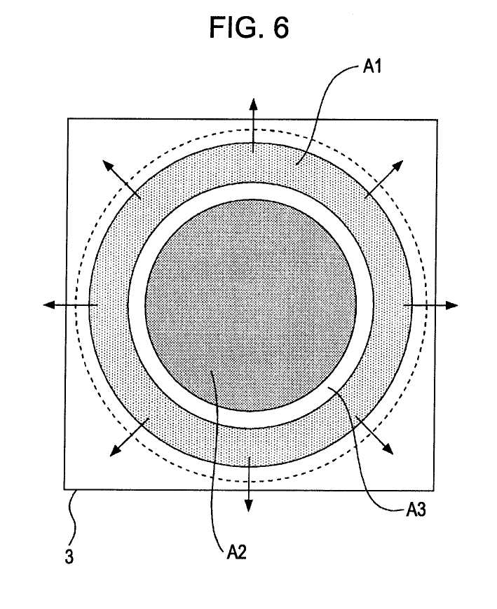

FIG. 6 shows an image. As shown in FIG. 6, the size of the reference light can be enlarged by performing the intensity modulation on the incident light such that the reference light area A1 is enlarged in the SLM 3, for example. On the contrary, the size of the reference light can be reduced by performing the intensity modulation on the incident light such that the reference light area A1 is reduced.

As can also be understood from this, the zoom power of the reference light may also be adjusted by the spatial light modulation of the SLM 3.

When the zoom power of the reference light is adjusted by the spatial light modulation of the SLM 3, the control section 15 performs the zoom power setting control. Specifically, the control section 15 instructs the modulation control section 13 to perform the intensity modulation for generation of reference light in the SLM 3 according to the size of the reference light area A1 to be set in response to the value of the reference light zoom power variation, which will be described later. By executing the driving control of the SLM 3 by the modulation control section 13 in response to the instruction, the adjustment of the zoom power of the reference light using the spatial light modulation of the SLM 3 is realized.

Moreover, for clarity, it is preferable that the adjustment of the zoom power of reference light is performed using at least one of the spatial light modulation of the SLM 3 and the zoom power adjusting section 9.

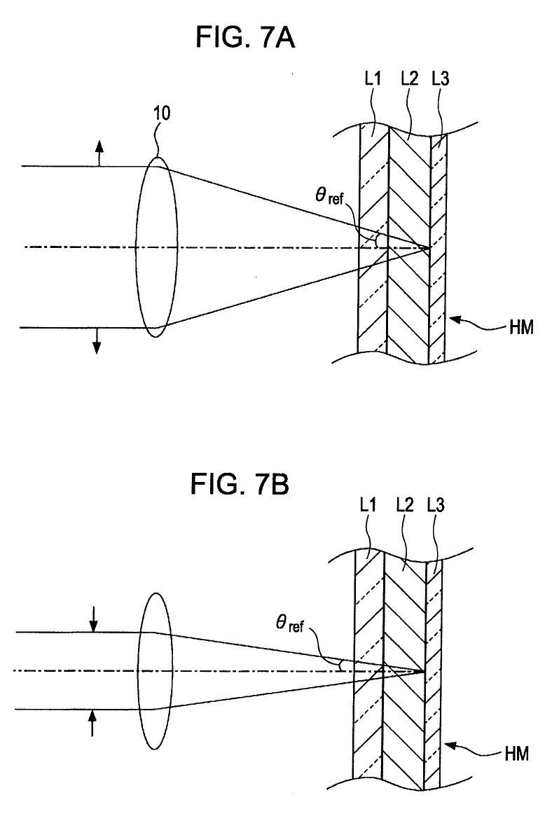

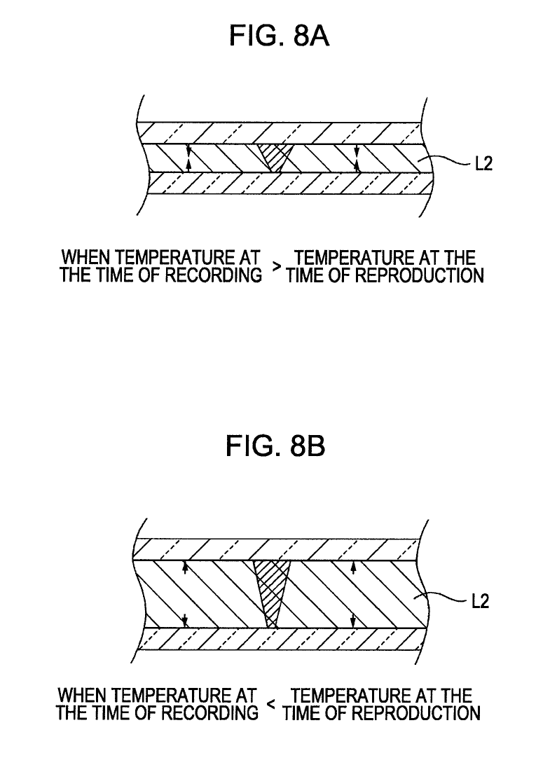

Here, for clarity, an operation by the adjustment of the zoom power of reference light will be described with reference to FIGS. 7A to 8B.

FIGS. 7A and 7B schematically show the states of light beams, which illuminate the hologram recording medium HM through the objective lens 10 shown in FIG. 1, at the time of enlargement (FIG. 7A) and reduction (FIG. 7B) of reference light.

As is apparent from FIGS. 7A and 7B, when the reference light size is enlarged/reduced by the zoom power adjustment, the incidence angle θref of the reference light which illuminates the hologram recording medium HM through the objective lens 10 changes. Specifically, at the time of enlargement shown in FIG. 7A, the incidence angle θref of the reference light becomes large. On the contrary, at the time of reduction shown in FIG. 7B, the incidence angle θref of the reference light becomes small.

Moreover, for clarity, an ON/OFF (lighting/no lighting) pattern is given to the reference light in the pixel unit. That is, the reference light may be considered as a group of light beams for every pixel.

In the recording/reproduction apparatus shown in FIG. 1, the objective lens 10 is formed as a convex lens which makes light beams, which are incident as parallel beams, converge at one point on the optical axis. Under such an assumption, each light beam for every pixel within the reference light, that is, light beams from a light beam located at the outermost peripheral portion to a light beam located at the innermost peripheral portion have a different NA (Numerical Aperture) as described above. Specifically, the NA value of a light beam located at the outer peripheral side is large (incidence angle θref is large), and the NA value of a light beam located at the inner peripheral side is small (incidence angle θref is small).

If the size of the reference light is enlarged/reduced by performing the zoom power adjustment as described above, the incidence angle θref of each light beam for every pixel within the reference light becomes large/small.

Moreover, in this specification, the “incidence angle of reference light” refers to the incidence angle of a light beam for every pixel within the reference light. In FIGS. 7A and 7B, the incidence angle θref of a light beam of a pixel located at the outermost periphery is representatively shown for convenience of illustration.

FIGS. 8A and 8B schematically show the states where the media temperature (temperature of the hologram recording medium HM) at the time of reproduction has changed from the temperature at the time of recording. Moreover, FIGS. 8A and 8B schematically show the state of the hologram recording medium HM (particularly, the recording layer L2) and the state of a hologram (diagonally shaded portion in FIGS. 8A and 8B) formed (recorded) in the recording layer L2, respectively, at the time of reproduction.

FIG. 8A shows the state when the temperature at the time of recording is higher than that at the time of reproduction (that is, when the temperature drops at the time of reproduction), and FIG. 8B shows the state when the temperature at the time of recording is lower than that at the time of reproduction (that is, when the temperature rises at the time of reproduction).

In addition, although it is necessary to show the change for every pixel in order to accurately describe the change of a hologram in response to the volume change of the recording layer L2, the change of the hologram is roughly shown in the unit of a page herein for convenience of illustration and for simplicity of explanation.

As shown in FIG. 8A, when the temperature at the time of recording is higher, the angle of a hologram tends to become large at the time of reproduction.

When the temperature is high at the time of recording, the recording layer L2 at the time of recording expands similarly to that shown in FIG. 8B. As a result, the hologram is formed in the same shape as that shown in the FIG. 8B. When the temperature drops to contract the recording layer L2 from this state, the state of the recording layer L2 and hologram formed in the recording layer L2 becomes similar to the state shown in FIG. 8A. When this is compared with the case shown in FIG. 8B, it can be understood that the angle of the hologram becomes large.

Here, the above explanation is based on the premise that the expansion/contraction of the recording layer L2 occurs only in the vertical direction (direction orthogonal to a direction parallel to the recording surface: direction parallel to the optical axis of laser light illuminating the hologram recording medium HM) in response to the rise/drop in temperature.

The reason why only the expansion/contraction in the vertical direction is considered is because the hologram recording medium HM is formed in the shape in which the recording layer L2 is interposed between substrates as shown in FIG. 2. That is, according to such a structure, the force of a hologram recording material as the recording layer L2 that expands/contracts in a direction parallel to the recording surface (also called an in-recording-surface direction) is suppressed by the substrate (cover layer L1 or substrate L3). Particularly when a material with a relatively low coefficient of thermal expansion (coefficient of linear expansion), such as a glass substrate, is selected as the cover layer L1 or the substrate L3, it can be expected that expansion/contraction of the recording layer L2 in the in-recording-surface direction hardly occurs.

Thus, since the expansion/contraction of the recording layer L2 occurs mainly in the vertical direction, the width of the hologram formed hardly changes at the time of both expansion and contraction. Accordingly, it can be thought that only the angle of the hologram mainly changes as described above with temperature change.

On the other hand, when the temperature at the time of recording is lower as shown in FIG. 8B, the angle of a hologram tends to become small at the time of reproduction. That is, when the temperature is low at the time of recording, the recording layer L2 at the time of recording contracts similar to that shown in FIG. 8A. As a result, the hologram is formed in the same shape as that shown in the FIG. 8A. When the temperature rises to expand the recording layer L2 from this state, the expansion occurs mainly in the vertical direction as described above. Accordingly, the width of the formed hologram hardly changes and the formed hologram expands only in the vertical direction. As a result, as can be seen from the comparison with FIG. 8A, the angle of a hologram tends to become small when the temperature rises at the time of reproduction.

If the media temperature at the time of recording is different from that at this time of reproduction, the angle of a hologram at the time of reproduction becomes different from that at the time of recording.

Here, a hologram is formed by interference between signal light, which is incident at a certain incidence angle θsig at the time of recording, and reference light incident at a certain incidence angle θref. Accordingly, when the temperature changes from the temperature at the time of recording and the angle of a hologram changes from the angle at the time of recording as described above, it is difficult to properly reproduce the hologram if illumination of the reference light is performed at the same incidence angle θref as when the recording was performed.

For this reason, when a temperature change occurs, the incidence angle θref of the illuminating reference light is changed in response to the changed angle of the hologram. Specifically, when the temperature at the time of recording shown in FIG. 8A is higher than that at the time of reproduction (when the temperature drops at the time of reproduction), the incidence angle θref of the reference light is adjusted to become large as the angle of the hologram becomes large. That is, the adjustment is performed such that the zoom power is increased.

On the other hand, when the temperature at the time of recording shown in FIG. 8B is lower than that at the time of reproduction (when the temperature rises at the time of reproduction), an adjustment is performed such that the incidence angle θref of the reference light becomes small as the angle of the hologram becomes small in order to reduce the zoom power.

### 2. Derivation of Conditional Expression for Prevention of Image Blur

<2-1. Outline of Explanation>

As pointed out previously, when the coaxial method is adopted as a hologram recording/reproduction method, many diffraction grating vectors act for recording/reproduction of one signal pixel. Accordingly, when there is a change in each angle of diffracted light, the reproduced image is blurred. As a result, the SN ratio (S/N) drops significantly. From this point of view, not only improving the diffraction efficiency but also preventing an image blur is important in temperature compensation using the coaxial method.

Hereinbelow, the change of physical properties by temperature change of media and the influence on recording/reproduction will be described first, and then a mechanism regarding how the image blur occurs and derivation of the reproduction condition in which the image blur does not occur will be described.

<2-2. Temperature Dependency of Hologram Media>

(2-2-1. Change of Physical Properties in Response to Temperature Change)

˜Volume Change˜

In the case of a hologram recording material the representative of which is a photopolymer, for example, the thermal expansion is basically isotropic. However, when the hologram recording material is practically used as a recording layer of a hologram recording medium, the volume change is not isotropic but anisotropic due to the structure where the hologram recording material is interposed between protective substrates (for example, the cover layer L1 and the substrate L3 shown in FIG. 2) with different coefficients of linear expansion.

As described previously, in the media using a protective substrate with a small coefficient of linear expansion, such as glass, the volume change caused by temperature change is dominant in the vertical direction (hologram thickness direction: hereinafter, also expressed as z direction). The thickness variation is determined mainly by the expansion and contraction of the recording material itself, and is expressed as [Expression 1]

ΔL_{T}=C_{TEZ}ΔTL₀ [Expression 1]

Here, C_{TEZ} is a coefficient of linear expansion of a recording material, ΔT is the temperature variation (difference between media temperatures at the time of recording and reproduction), and L₀ is the thickness of a recording layer.

On the other hand, when a recording layer is interposed between substrate materials with relatively large coefficients of linear expansion, such as a polycarbonate substrate, the volume change also occurs in an in-recording-surface direction (direction orthogonal to the vertical direction: hereinafter, also expressed as x direction) according to thermal expansion and contraction of the substrates. Assuming that the area illuminated with light is W₀, the temperature expansion/contraction in the x direction is expressed as [Expression 2].

ΔW_{T}=C_{TEZ}ΔTW₀ [Expression 2]

C_{TEX} is a coefficient of linear expansion of the protective substrate.

Moreover, contraction caused by the polymerization reaction of a monomer at the time of recording also occurs in addition to the volume change caused by temperature change. The volume change of the recording material under this influence is expressed as [Expression 3] and [Expression 4].

ΔL_{S}=σ_{Z}L₀ [Expression 3]

ΔW_{S}=σ_{X}W₀ [Expression 4]

In [Expression 3] and [Expression 4], σ_{X} and σ_{Z} are recording material contraction rates in the x and z directions according to polymerization, respectively (σ_{X}, σ_{Z}<0). In this case, the volume change of a hologram including contraction caused by temperature change and polymerization is expressed as [Expression 5] and [Expression 6].

$$\begin{matrix}\begin{matrix}Δ L = Δ {L}_{T} + Δ {L}_{S} \\ = ( {C}_{TEZ} Δ T + {σ}_{Z} ) {L}_{0}\end{matrix} & [ Expression 5 ] \\ \begin{matrix}Δ W = Δ {W}_{T} + Δ {W}_{S} \\ = ( {C}_{TEX} Δ T + {σ}_{X} ) {W}_{0}\end{matrix} & [ Expression 6 ]\end{matrix}$$

˜Change of Refractive Index˜

Next, a change in the average refractive index at the time of reproduction will be considered. A refractive index n_{R} of a recording material at the time of reproduction is also a function of the temperature variation ΔT. Since the value of temperature gradient v (=dn/dT) of a refractive index is an approximately constant value when the temperature change is small, the refractive index n_{R} at the time of reproduction may be approximated to a straight line of [Expression 7].

n_{R}(ΔT)=n_{W}+vΔT+Δn_{Poly} [Expression 7]

In a typical photopolymer material, v<0 and the refractive index n_{R} decreases as the temperature rises. Δn_{Poly} at the third term of [Expression 7] is an average refractive index change caused by the polymerization reaction after recording.

(2-2-2. Reduction in Diffraction Efficiency by Bragg Mismatching)

When a volume change or a refractive index change occurs, it is difficult to perform the data reproduction properly even if the reproduction is performed after recording by illumination of the same reference light as when the recording was performed, since the diffraction efficiency is largely reduced. Generally, this phenomenon is explained by the selectivity of Bragg diffraction in a thick hologram (regarding this point, see H. J. Coufal, D. Psaltis, and G. T. Sincerbox, eds., Holographic Data Storage, Vol. 76 of Springer Series in Optical Sciences (Springer-Verlag, Berlin, 2000)).

Here, as a simplest example, single recording in which two plane waves (signal light and reference light) are incident on a hologram recording material will be described first.

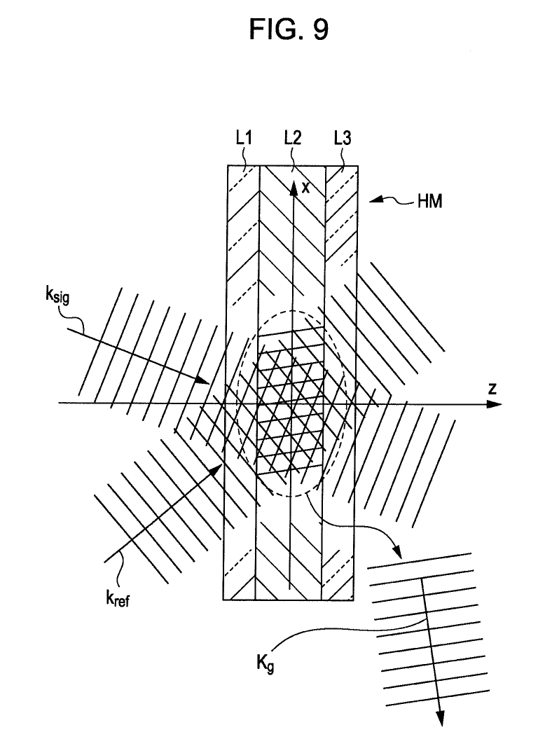

FIG. 9 is a diagram illustrating the relationship between a wave vector and a diffraction grating vector in the hologram recording process. FIG. 9 schematically shows the hologram recording medium HM as well as the signal light and reference light (both are light beams for one pixel) which illuminate the hologram recording medium HM at the time of recording. In addition, FIG. 9 shows the relationship between the x and z directions.

As shown in FIG. 9, refractive index modulation of a recording material caused by two beam interference between infinite plane waves generates a diffraction grating with a single spatial frequency (this is the most basic hologram). A diffraction grating vector (grating vector) which specifies the pitch and azimuth direction of the refractive index grating is defined by [Expression 8].

K_{g}=k_{sig}−k_{ref} [Expression 8]

Here, k_{sig} and k_{ref} shown in FIG. 9 are wave vectors which express signal light and reference light, respectively, and |k_{sig}|=|k_{ref}|=k_{W}=2πn_{W}/λ_{W} (λ_{W} is a recording wavelength).

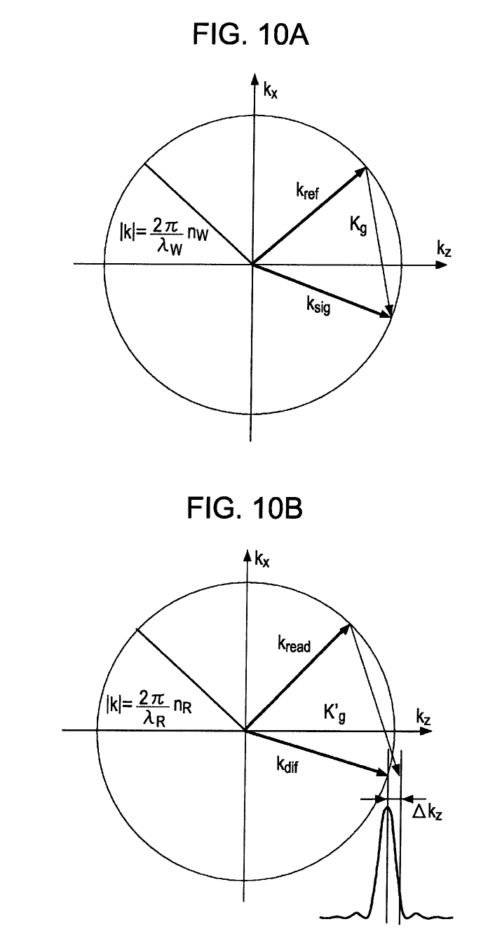

The grating vector and wave vector can be treated as being located on the sphere (Ewald sphere) with a radius of |k|=k_{W} on the K space as shown in FIGS. 10A and 10B, for example. The direction of the grating vector K_{g} indicates a normal direction of the direction of the volume grating, and the length of the grating vector K_{g} has the relationship of inverse number of the grating pitch Λ, which is expressed as [Expression 9].

$$\vert {K}_{g} \vert = \frac{2 π}{Λ} \qquad [ Expression 9 ]$$

This originates from the fact that the spatial frequency, which is the size of a grating vector, and the real space position of hologram refractive index modulation are a Fourier transform pair.

Next, hologram reproduction will be considered. The spatial frequency distribution of an actual hologram is not a delta function on the grating vector space but shows a finite spread (uncertainty), diffracted light is generated even if the Bragg condition is not completely satisfied. When this is taken into consideration, the relationship between wave vectors of reproduction reference light (reference light at the time of reproduction) k_{read} and diffracted signal light (reproduced light) k_{dif} becomes similar to [Expression 10].

k_{dif}=k_{read}+K′_{g}+Δk [Expression 10]

Here, k_{read} and k_{dif} are vectors on the Ewald sphere which satisfies |k|=k_{R}=2πn_{R}/λ_{R} (λ_{R} is a reproduction wavelength). The finite spread Δk is called the “Bragg mismatch amount”, and is a parameter indicating the degree of angular deviation or positional deviation from the Bragg condition. K′_{g} is a grating vector of a hologram at the time of reproduction. The case of |Δk|=0, that is, [Expression 11] is called the Bragg condition (Bragg's condition).

K′_{g}=k_{dif}−k_{read} [Expression 11]

From [Expression 8] and [Expression 11], the Bragg condition becomes k_{sig}=k_{dif} when a hologram is in the same state (K_{g}=K′_{g}) as when the recording was performed and reproduction (k_{ref}=k_{read}) is performed using the same reference light. Accordingly, diffracted light is generated in the same direction as when the recording was performed. This is the reproduction principle of a normal volume hologram.

According to Kogelnik's coupled wave theory (see H. W. Kogelnik, “Coupled wave theory for thick hologram gratings”, Bell Syst. Tech. J., Vol. 48, pp. 2909?2947 (1969)), the diffraction efficiency η of a hologram recorded by interference between two light beams may be described as the following simple expression by assuming that only the hologram thickness direction (z direction) has a finite opening with a width L₀ and the in-recording-surface direction (x direction) has infinite spread (that is, Δk has only a k_{Z} direction component).

$$η = {η}_{0} sin {c}^{2} ( \frac{Δ {k}_{z} {L}_{0}}{2} ) \qquad [ Expression 12 ]$$

Here, η₀ is the diffraction efficiency at the time of recording, and Δk_{Z} is the mismatch amount in the k_{Z} direction here (|Δk|=Δk_{Z}). In addition, the sinc function in [Expression 12] is defined by [Expression 13].

$$sin c ( x ) ≡ ( \frac{sin ( π x )}{π x} ) \qquad [ Expression 13 ]$$

FIGS. 10A and 10B show the selectivity of the Bragg diffraction on the K space. FIG. 10A shows the relationship between wave vector and grating vector of signal light and reference light at the time of recording, and FIG. 10B shows the relationship between wave vector and grating vector of diffracted signal light and reference light at the time of reproduction.

When the diffracted light k_{dif} is positioned exactly on the surface of the Ewald sphere, Δk_{Z}=0. In this case, the diffraction efficiency becomes the maximum. The sinc function having the amount of phase mismatch (shift amounts of angle and wavelength) on the horizontal axis, which is shown in FIGS. 10A and 10B, is called Bragg selectivity.

When the volume change of a recording material occurs after hologram recording, both the grating pitch and the direction change. This change corresponds to the enlargement/reduction of the grating vector and may be described as in [Expression 14], [Expression 15], and [Expression 16].

$$\begin{matrix}{L}_{0} + Δ {L}_{T} = {L}_{0} ( 1 + {C}_{TEZ} Δ T + {σ}_{Z} ) & [ Expression 14 ] \\ {W}_{0} + Δ {W}_{T} = {W}_{0} ( 1 + {C}_{TEX} Δ T + {σ}_{X} ) & [ Expression 15 ] \\ {k}_{g}^{′} = ( \begin{matrix}\frac{{K}_{gZ}}{1 + {C}_{TEZ} Δ T + {σ}_{Z}} \\ \frac{{K}_{gX}}{1 + {C}_{TEX} Δ T + {σ}_{X}}\end{matrix} ) & [ Expression 16 ]\end{matrix}$$

Here, K_{gZ} and K_{gX} are k_{Z} component and k_{X} component of the grating vector, respectively.

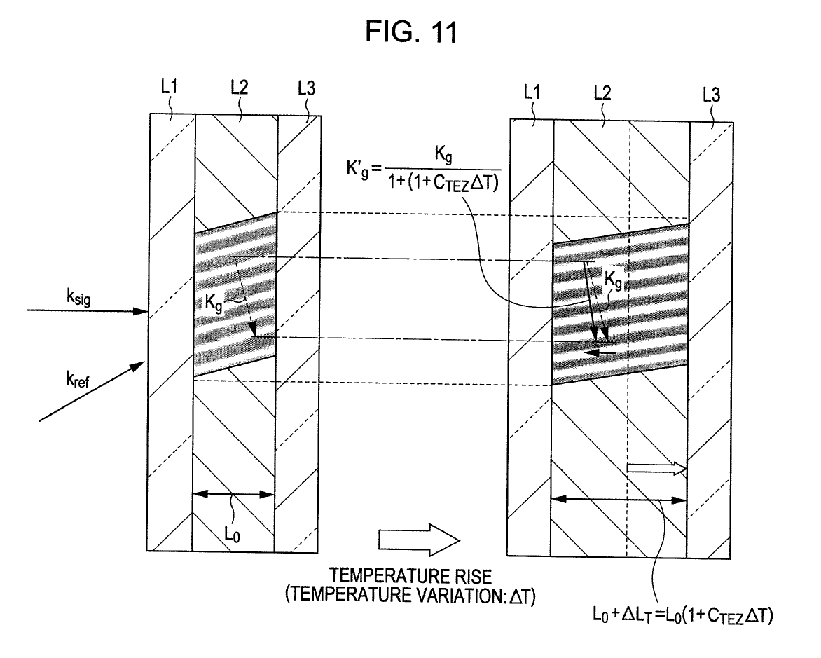

FIG. 11 schematically shows the state where a hologram expands with a rise in temperature and a grating vector is reduced with the expansion.

As shown in FIG. 11, when the expansion/contraction caused by temperature change occurs only in the vertical direction, only a component in the thickness direction is reduced in the grating vector change. When the temperature change occurs, K_{g} ≠K′_{g}. Accordingly, when illumination of the same reference light as when the recording was performed is performed, the Bragg condition is inevitably not satisfied.

In addition, [Expression 7] expressing the temperature dispersion of a refractive index becomes a cause of the Bragg mismatch at the time of reproduction, that is, a reduction in the diffraction efficiency. In this case, the grating vector K_{g} itself does not change, but the lengths and directions of the reproduction reference light k_{read} and diffracted signal light k_{dif} change.

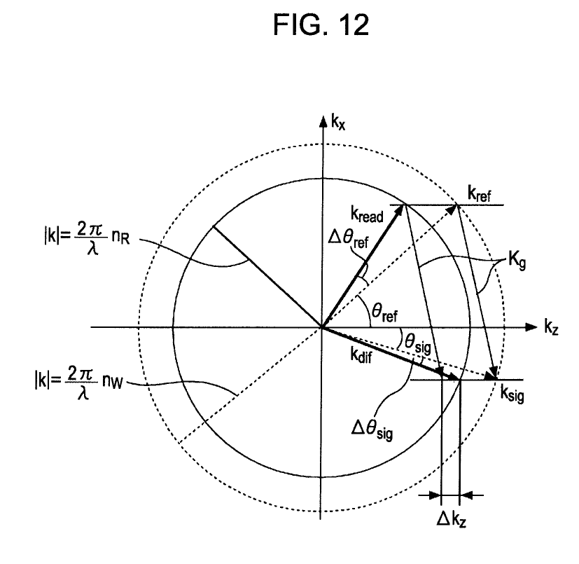

FIG. 12 shows the Bragg mismatch, which occurs when only the average refractive index of a recording material is reduced after hologram recording, on the K space. If only the refractive index of a recording material changes, Snell's law, expressed by [Expression 17] and [Expression 18], is satisfied between the external incidence angles before and after a change.

Sin Θ_{sig}=n_{W} sin θ_{sig}=n_{R} sin(θ_{sig} Δθ_{sig}) [Expression 17]

Sin Θ_{ref}=n_{W} sin θ_{ref}=n_{R} sin(θ_{ref} Δθ_{sig}) [Expression 18]

Here, Θ_{sig} and Θ_{ref} in [Expression 17] and [Expression 18] indicate the external incidence angle of signal light and the external incidence angle of reference light, respectively. Moreover, θ_{sig}+Δθ_{sig} and θ_{ref}+Δθ_{ref} are the internal angle of diffracted signal light and the internal angle of reproduction reference light, respectively (in FIG. 12, the signal light angle is negative).

The relationship between [Expression 17] and [Expression 18] means that the k_{Z} direction components in wave vectors of reproduction reference light and diffracted signal light are enlarged (reduced) by an increase (decrease) in the average refractive index. On the other hand, since this case is based on the premise that the volume change does not occur and only the refractive index change occurs, the grating vector K_{g} does not change.

As a result, the mismatch amount Δk_{Z} is generated as shown in FIG. 12 and the diffraction efficiency is reduced.

(2-2-3. Maximization and Equalization of Page Diffraction Efficiency)

The change of the physical properties of a hologram caused by temperature change, which has been described above, may be compensated for by appropriately adjusting the incidence angle or wavelength of reference light in response to the temperature change.

Here, it should be noted that many grating vectors are to be compensated for simultaneously in actual hologram recording.

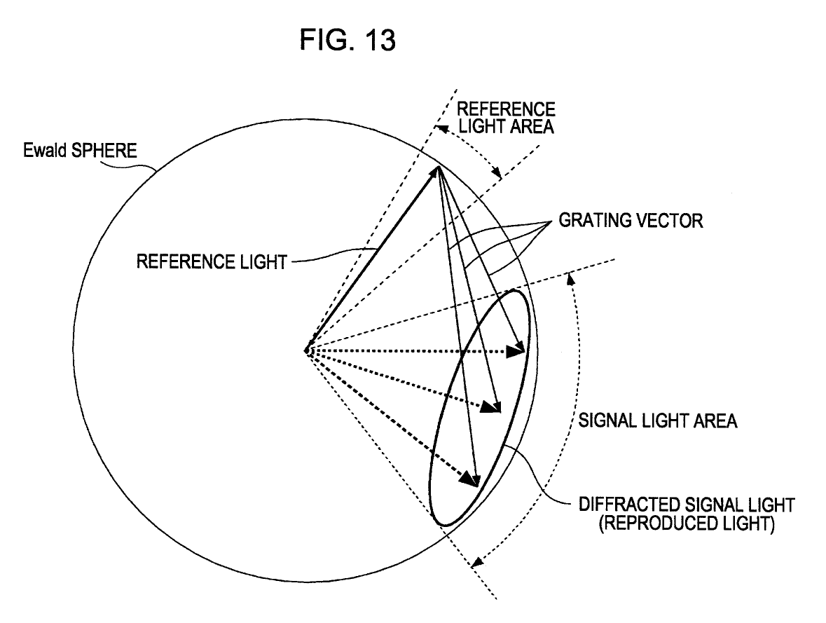

FIG. 13 is a diagram which expresses the state at the time of hologram reproduction on the K space. FIG. 13 schematically shows the relationship among reference light (and the reference light area), a grating vector, and diffracted signal light (and the signal light area) on the K space.

Since the signal to be compensated is a data page which spreads at a wide angle as shown as diffracted signal light in FIG. 13, it is necessary to adjust the incidence condition of reference light so that the diffraction efficiency of the entire page becomes maximum and equal.

However, in normal correction using only one of the incidence angle of reference light or the wavelength, the diffraction efficiency changes (brightness and darkness of a reproduced image occur) within the page. As a result, it is difficult to make the light amount distribution of the reproduced image uniform (for example, see Japanese Unexamined Patent Application Publication No. 2006-349831 or 2007-240820 which was described previously). In order to realize the optimal incidence condition of reference light, it is effective to change both the incidence angle of reference light and the wavelength.

(2-2-4. Image Blur in a Coaxial Method)

Moreover, particularly in the temperature compensation using the coaxial method, not only improvement and equalization of the diffraction efficiency are important, but also it is important to make the emission angle of reproduced light (diffracted signal light) unchanged even after the compensation in order to prevent the occurrence of an image blur.

For example, when a so-called two beam method is adopted in which signal light and reference light are not disposed on the same optical axis, the emission angle of reproduced light at the time of temperature compensation may slightly deviate in response to the incidence condition, but substantially it hardly affects the SN ratio since the reproduced image only shifts horizontally.

On the other hand, in the coaxial method, a reproduced image of one signal pixel is superposition of diffracted light diffracted by many grating vectors since reference light with a wide angle spectrum is used, as can also be understood from the previous explanation. For this reason, when the compensation is performed taking only the diffraction efficiency into consideration and as a result, the emission angles of diffracted signal light beams become different, the diffracted light beams are not condensed at one pixel. As a result, the reproduced image is blurred.

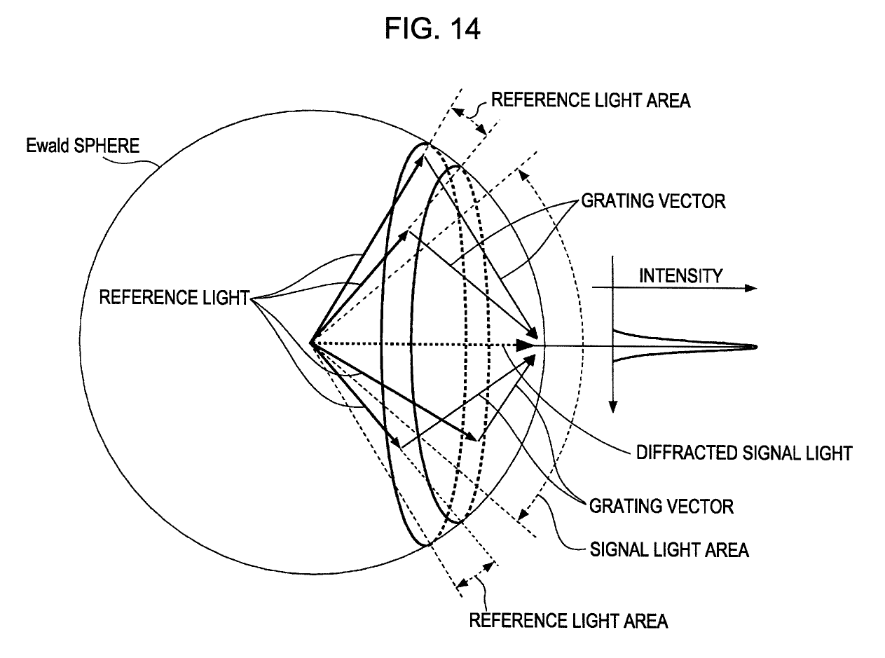

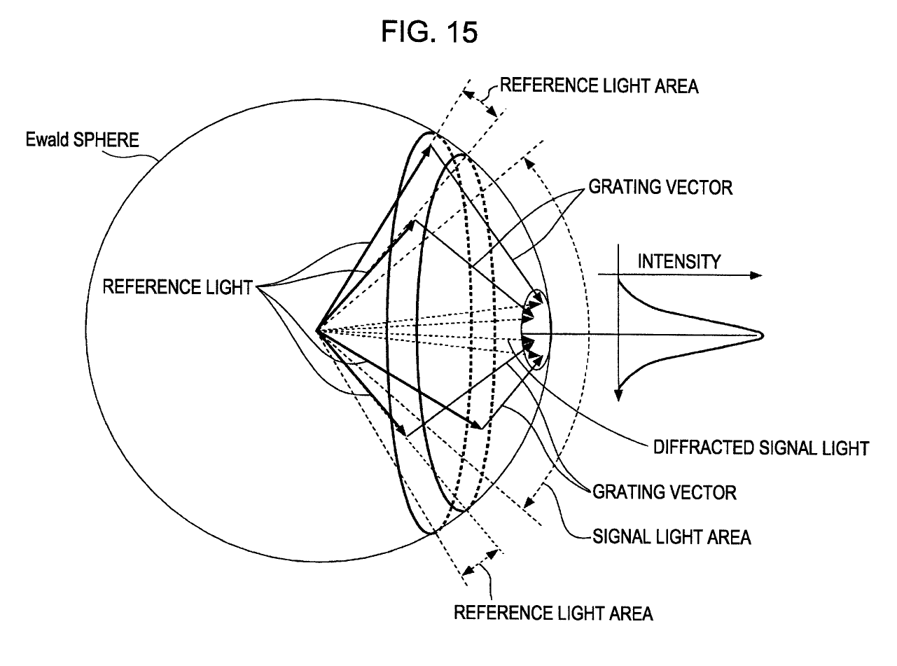

An image of image blur will be described with reference to FIGS. 14 and 15. FIG. 14 schematically shows the relationship among reference light (and the reference light area), a grating vector, and diffracted signal light (and the signal light area) on the K space at the time of normal reproduction (when there is no deviation in the emission angle of diffracted signal light: when there is no image blur). FIG. 15 schematically shows the relationship among reference light (and the reference light area), a grating vector, and diffracted signal light (and the signal light area) on the K space when the emission angle of diffracted signal light deviates (when there is an image blur). In addition, FIGS. 14 and 15 also show the intensity distribution of the diffracted signal light.

As is apparent from FIGS. 14 and 15, in the coaxial method, diffracted light beams from many grating vectors contribute to the signal reproduction of one pixel. Accordingly, if the emission angle of diffracted signal light deviates, the reproduced image inevitably becomes blurred.

As described above, when such an image blur occurs, crosstalk with other pixels (data) occurs. As a result, the SN ratio drops significantly. For this reason, when performing temperature compensation in the coaxial method, it becomes necessary to set the reproduction condition in which the image blur does not occur.

<2-3. Derivation of Conditional Expression Based on Theoretical Analysis>

Next, the reproduction condition for preventing the occurrence of the image blur is derived. For the sake of simplicity, the wave vector space is limited to the two-dimensional plane of (k_{S}, k_{X}) in the following explanation (although three-dimensional derivation is also possible, the conditional expression obtained as a result is the same because the optical system in the coaxial method is rotationally symmetric with respect to the z axis).

First, k_{Z} and k_{X} components of wave vectors of signal light and reference light are expressed as [Expression 19] and [Expression 20], respectively.

$$\begin{matrix}{k}_{sig} = ( \begin{matrix}{k}_{sigZ} \\ {k}_{sigX}\end{matrix} ) = ( \begin{matrix}{k}_{W} cos {θ}_{sig} \\ {k}_{W} sin {θ}_{sig}\end{matrix} ) & [ Expression 19 ] \\ {k}_{ref} = ( \begin{matrix}{k}_{W} cos {θ}_{ref} \\ {k}_{W} sin {θ}_{ref}\end{matrix} ) & [ Expression 20 ]\end{matrix}$$

A grating vector of a hologram recorded by interference between these components becomes like [Expression 21] from [Expression 8].

$${K}_{g} = {k}_{W} ( \begin{matrix}cos {θ}_{sig} - cos {θ}_{ref} \\ sin {θ}_{sig} - sin {θ}_{ref}\end{matrix} ) \qquad [ Expression 21 ]$$

Accordingly, the grating vector after expansion/contraction caused by temperature change becomes like [Expression 22] from [Expression 16].

$${K}_{g }^{′} = {k}_{W} ( \begin{matrix}\frac{cos {θ}_{sig} - cos {θ}_{ref}}{1 + {C}_{TEZ} Δ T + {σ}_{Z}} \\ \frac{sin {θ}_{sig} - sin {θ}_{ref}}{1 + {C}_{TEX} Δ T + {σ}_{X}}\end{matrix} ) \qquad [ Expression 22 ]$$

As described previously, in the temperature compensation, it is effective to adjust both the incidence angle and the light wavelength for the reproduction reference light k_{read}. In this case, the reproduction reference light k_{read} is expressed as [Expression 23] when the influence by the amount of adjustment of the wavelength (wavelength variation) and the temperature dispersion in [Expression 17] is taken into consideration.

$$\begin{matrix}{k}_{read} = {k}_{R} ( \begin{matrix}cos ( {θ}_{ref} + Δ {θ}_{ref} ) \\ sin ( {θ}_{ref} + Δ {θ}_{ref} )\end{matrix} ) \\ = \frac{2 π ( {n}_{W} + v Δ T + Δ {n}_{poly} )}{{λ}_{W} + Δ λ} \\ ( \begin{matrix}cos ( {θ}_{ref} + Δ {θ}_{ref} ) \\ sin ( {θ}_{ref} + Δ {θ}_{ref} )\end{matrix} )\end{matrix} \qquad [ Expression 23 ]$$

Here, for clarity, [Expression 10] which is the relational expression of the wave vector k_{read} of reproduction reference light, the wave vector k_{dif} of diffracted signal light, the grating vector K′_{g}, and the Bragg mismatch amount Δk are described again.

k_{dif}=k_{read}+K′_{g}+Δk [Expression 10]

In this case, Δk is expressed as [Expression 24].

$$Δ k = ( \begin{matrix}Δ {k}_{Z} \\ 0\end{matrix} ) \qquad [ Expression 24 ]$$

In order to prevent the image blur, it is preferable to set the emission angle of diffracted light to be constant at the arbitrary recording light angles θ_{sig} and θ_{ref}. Now, the situation where the k_{X} component, which determines the emission angle (that is, the position on the actual image surface) of the illuminating signal light k_{sig} and diffracted signal light k_{dif} at the time of recording, is saved before and after temperature compensation will be considered.

When the k_{X} component of k_{sig} in [Expression 19] is compared with the k_{X} component of k_{dif} (=k_{read}+K′_{g}+Δk) in [Expression 10], [Expression 25] is obtained.

$${k}_{W} sin {θ}_{sig} = {k}_{R} sin ( {θ}_{ref} + Δ {θ}_{ref} ) + \frac{{k}_{W}}{1 + {C}_{TEX} Δ T + {σ}_{X}} ( sin {θ}_{sig} - sin {θ}_{ref } ) \qquad [ Expression 25 ]$$

Here, the case where the compensation for the temperature change is performed mainly by changing the zoom power of reference light is considered. First, the zoom power m of reference light is defined as follows.

$$\begin{matrix}m = 1 + Δ m \\ ≡ \frac{sin ( {Θ}_{ref} + Δ {Θ}_{ref} )}{sin {Θ}_{ref}} \\ = \frac{{n}_{R} sin ( {θ}_{ref} + Δ {θ}_{ref} )}{{n}_{W} sin {θ}_{ref}}\end{matrix} \qquad [ Expression 26 ]$$

Moreover, for clarity, the zoom power variation Δm of reference light indicates the amount of change from the reference light zoom power at the time of recording.

If [Expression 25] is rewritten using [Expression 26], the relationship of [Expression 27] is obtained.

$$\frac{( 1 + Δ m ) sin {θ}_{ref}}{{λ}_{W} + Δ λ} = \frac{sin {θ}_{ref} + ( {C}_{TEX} Δ T + {σ}_{X} ) sin {θ}_{sig}}{{λ}_{W} ( 1 + {C}_{TEX} Δ T + {σ}_{X} )} \qquad [ Expression 27 ]$$

Regarding the second term of the right side in [Expression 27], the relationship of sin θ_{ref}>> (C_{TEX}ΔT+σ_{X}) sin θ_{sig} is satisfied in most cases. Accordingly, when (C_{TEX}ΔT+σ_{X}) sin θ_{sig} is neglected, the relational expression [Expression 28] of the zoom power variation Δm and the wavelength variation Δλ is derived.

$$1 + Δ m = \frac{1}{( 1 + {C}_{TEX} Δ T + {σ}_{X} )} ( 1 + \frac{Δ λ}{{λ}_{W}} ) \qquad [ Expression 28 ]$$

In addition, each change width has an order of 10⁻³ or less. Accordingly, since the change width is very small compared with 1, [Expression 28] may be approximated to [Expression 29].

$$Δ m - \frac{Δ λ}{{λ}_{W }} + {C}_{TEX} Δ T + {σ}_{X} = 0 \qquad [ Expression 29 ]$$

In the conditional expression based on [Expression 28] and [Expression 29], the incidence angle dependency at the time of recording is not included. Accordingly, as long as this is satisfied, a clear reproduced image without image blur can be acquired even when the zoom power or wavelength of reference light is changed.

Here, particularly when it is considered that the volume change caused by temperature change occurs only in the vertical direction, for example, when a material with a relatively small coefficient of linear expansion, such as glass, is used as a protective substrate, a term related to expansion/contraction (C_{TEX}ΔT) of the recording material in the x direction or the thermal expansion (σ_{X}) of the substrate may be neglected. Therefore, in this case, the above conditional expression may be written as [Expression 30].

$$Δ m = \frac{Δ λ}{{λ}_{W}} \qquad [ Expression 30 ]$$

From [Expression 30], when the volume change caused by temperature change occurs only in the vertical direction, for example, when the wavelength is adjusted to become shorter by 1%, it is preferable to also reduce the zoom power by 1% in response to the wavelength decrease (if the center wavelength is set to 400 nm, Δλ=−4 nm and Δm=−0.01).

In addition, it should be noted that a term of the refractive index is not included in the conditional expressions ([Expression 28], [Expression 29], and [Expression 30]) for the prevention of image blur. This is because even if the refractive index changes as shown in FIG. 12, the wave vector is not changed and the k_{X} components of signal light and reference light are saved by Snell's law.

### 3. Derivation of Reproduction Condition for Improvement and Equalization of Diffraction Efficiency

Next, the temperature compensation condition for restoring the diffraction efficiency up to the same level as when the recording was performed (that is, restoring the diffraction efficiency up to the level when there is no temperature change) is derived after the image blur prevention condition is satisfied. Returning to [Expression 10], the k_{Z} components on both sides are compared.

Here, if a transmissive hologram that satisfies −π/2<θ_{sig}<π/2 and −π/2<θ_{ref}<π/2 is assumed and |k_{dif}|²=k_{R}² is used, [Expression 31] is obtained.

$$\sqrt{{k}_{R}^{2} - {\{ \begin{matrix}{k}_{R} sin ( {θ}_{ref} + Δ {θ}_{ref} ) + \\ \frac{{k}_{W} ( sin {θ}_{sig} - sin {θ}_{ref} )}{1 + {C}_{TEX} Δ T + {σ}_{X}}\end{matrix} \}}^{2}} = {k}_{R} cos ( {θ}_{ref} + Δ {θ}_{ref} ) + \frac{{k}_{W} ( cos {θ}_{sig} - cos {θ}_{ref} )}{1 + {C}_{TEZ} Δ T + {σ}_{Z}} + Δ {k}_{Z} \qquad [ Expression 31 ]$$

When this is rearranged using [Expression 26] and is solved for Δk_{Z}, [Expression 32] is obtained.

$$Δ {k}_{Z} = - \frac{{k}_{W}}{{A}_{Z}} ( \begin{matrix}cos {θ}_{sig} - \\ cos {θ}_{ref}\end{matrix} ) + \frac{{k}_{W}}{{B}_{X}} ( \begin{matrix}\sqrt{{C}_{Δ n} - {B}_{X}^{2} {sin}^{2} {θ}_{sig}} - \\ \sqrt{{C}_{Δ n} - {B}_{X}^{2} {sin}^{2} {θ}_{ref}}\end{matrix} ) \qquad [ Expression 32 ]$$

Here, the variables A_{Z}, B_{X}, and C_{Δn} are linear functions of ΔT expressed as [Expression 33], [Expression 34], and [Expression 35], respectively.

$$\begin{matrix}{A}_{Z} = 1 + {C}_{TEZ} Δ T + {σ}_{Z} & [ Expression 33 ] \\ {B}_{X} = ( 1 + Δ m ) ( 1 + {C}_{TEX} Δ T + {σ}_{X} ) & [ Expression 34 ] \\ {C}_{Δ n} = 1 + \frac{v Δ T + Δ {n}_{poly}}{{n}_{W }} & [ Expression 35 ]\end{matrix}$$

The variable A_{Z} indicates a volume change in the z direction, the variable B_{X} indicates correction performed by zoom and volume change in the x direction, and C_{Δn} indicates an influence of refractive index change. By balancing the variables appropriately so that ΔkZ=0 equivalent to the Bragg condition is satisfied, it is possible to restore the diffraction efficiency reduced due to the temperature change.

However, since the dependency of the signal light incidence angle ° _{sig} exists in [Expression 32], Δk_{Z}≠0 if only the temperature changes. In this case, not only is the diffraction efficiency reduced on the whole, but also the light amount distribution in an output data page becomes non-uniform due to the angular dependency.

Ideally, it is most desirable to set the reproduction condition which satisfies Δk_{Z}=0 for the entire data page, that is, arbitrary θ_{sig}.

Moreover, for clarity, although the term of C_{TEX}ΔT or σ_{X} related to the volume change in the in-recording-surface direction is also included in [Expression 34], these terms may also be omitted when there is the assumption that the volume change occurs only in the vertical direction.

### 4. Temperature-Compensated Image in which an Image Blur is Prevented

Here, when the grating vector on the K space is taken into consideration, the condition of [Expression 32] can be more intuitively understood.

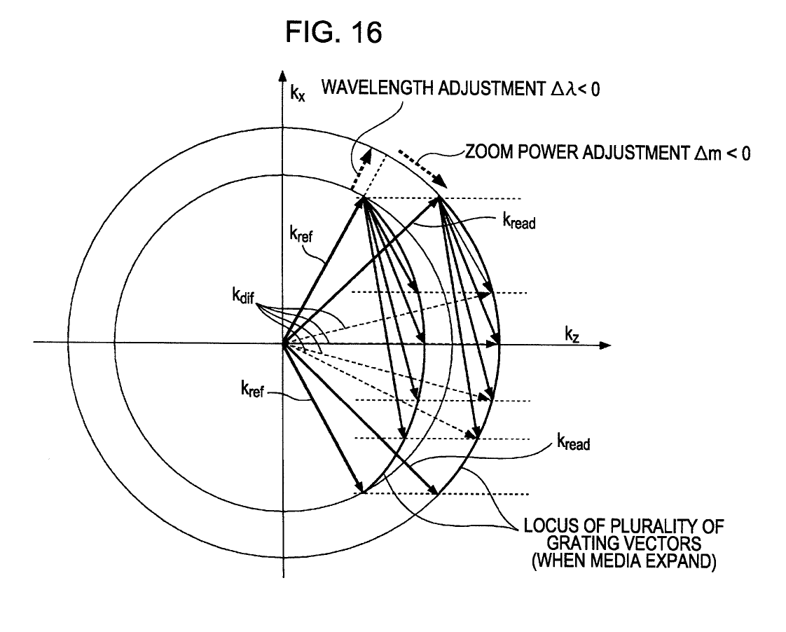

FIG. 16 is a diagram showing a temperature-compensated image, in which an image blur is prevented, on the K space. FIG. 16 shows a temperature-compensated image when the recording material has expanded in the z direction due to the temperature rise and also shows the relationship of the locus (large curve in FIG. 16), which is drawn by the reference light k_{ref}, the reproduction reference light k_{read}, the diffracted signal light k_{dif}, and a plurality of grating vectors at the time of recording, on the K space.

In addition, the plurality of grating vectors in FIG. 16 show grating vectors of each hologram recorded by one reference light and a plurality of signal light beams.

In FIG. 16, the locus drawn by a group (that is, a hologram) of grating vectors recorded by one reference light and a plurality of signal light beams is noted. When the expansion occurs in the z direction, the locus drawn by the group of the plurality of grating vectors is reduced in the k_{Z} direction. As a result, the surface that was originally spherical along the Ewald sphere is transformed into an ellipsoidal surface.

Accordingly, by adjusting the zoom power and the wavelength appropriately (Δλ<0, Δm<0) as shown in FIG. 16, the curvature of the ellipsoidal surface of the hologram locus and the curvature of the Ewald spherical surface can be made equal while keeping the k_{X} component (a plurality of horizontal broken lines in FIG. 16) of diffracted signal light. Thus, even if the temperature changes, the image blur can be prevented and the diffraction efficiency of the entire data page can be recovered by making Δk_{Z}=0 almost satisfied at all diffracted signal light angles.

### 5. Method of Determining Zoom Power and Wavelength for Realizing Temperature Compensation in which Image Blur is Prevented

The above explanation has been made up to now on the assumption that the diffraction efficiency is improved mainly by the adjustment of the zoom power of reference light. Accordingly, for the variable B_{X} in [expression 32], the zoom power variation Δm of reference light is included as shown in [Expression 34].

Thus, when it is assumed that the improvement in diffraction efficiency is realized mainly by the adjustment of the zoom power of reference light, in order to determine the combination of values of the zoom power variation Δm and wavelength variation Δλ which are to be set to realize the temperature compensation for preventing image blur, a process is performed in which the value of the zoom power variation Δm of the reference light for improving (improving and equalizing) the diffraction efficiency is first calculated for every temperature variation (ΔT) on the basis of [Expression 32] to [Expression 35] and then the value of the wavelength variation Δλ which satisfies the condition for the prevention of image blur, such as [Expression 28] or [Expression 30], is calculated from the value of the reference light zoom power variation Δm for every temperature variation. That is, the combination of the reference light zoom power variation Δm and the wavelength variation Δλ for realizing temperature compensation for prevention of image blur can be determined accordingly for every temperature change ΔT.

On the other hand, an improvement in diffraction efficiency may be realized mainly using the wavelength variation Δλ. In this case, the variable B_{X} in [Expression 32] is replaced with [Expression 36].

$${B}_{X} = ( 1 + Δ m ) ( 1 + {C}_{TEX} Δ T + {σ}_{X} ) = 1 + \frac{Δ λ}{{λ}_{W}} \qquad [ Expression 36 ]$$

In addition, [Expression 36] is based on [Expression 28].

Then, using [Expression 36] or [Expression 32], [Expression 33], and [Expression 35], the wavelength variation Δλ for improving the diffraction efficiency is calculated for every temperature variation ΔT, and then the value of the reference light zoom power variation Δm which satisfies the condition of [Expression 28] or [Expression 30] is calculated from the wavelength variation Δλ. As a result, each combination of the zoom power variation Δm and the wavelength variation Δλ for realizing temperature compensation for the prevention of image blur can be obtained.

For example, using one of the above methods, it is possible to determine each combination of the zoom power variation Δm and the wavelength variation Δλ which are to be set for every temperature variation ΔT in order to realize the temperature compensation for the prevention of image blur.

For example, the values of the zoom power variation Δm and wavelength variation Δλ which are determined as described above for every temperature variation ΔT are stored in the adjustment value table 16a shown in FIG. 1.

However, the above-described methods of determining the combination of values of the zoom power variation Δm and wavelength variation Δλ are only examples. In another method, for example, an experiment for actually causing a temperature change is performed, the value of the zoom power variation Δm (or the wavelength variation Δλ) for the improvement and equalization of the diffraction efficiency against the temperature change is searched for first, and then the value of the wavelength variation Δλ (or the zoom power variation Δm) which satisfies an image blur prevention condition ([Expression 28] or [Expression 30]) is calculated from the value of each temperature variation ΔT obtained as a result of the search. Thus, the values of Δm and Δλ to be stored in the adjustment value table 16a may be determined.

In the present invention, any method may be adopted as long as the values of zoom power and wavelength of the reference light, which are to be adjusted for every temperature variation, satisfy the image blur prevention condition shown in [Expression 28] or [Expression 30]. Thus, an image blur occurring at the time of temperature compensation can be prevented.

In other words, in the present invention, a method of determining the zoom power or the wavelength for improving the diffraction efficiency is not particularly limited. However, regarding the prevention of image blur, it is necessary to determine the combination of reference light zoom power and wavelength such that the image blur prevention condition presented previously is satisfied.

Moreover, for example, when the value for every temperature variation is determined by experiment, it becomes easy to acquire a rough view on the entire page by calculating the optimal temperature compensation condition at sin θ_{sig}=0 corresponding to the center of a data page by calculation using [Expression 32] to [Expression 35] (or [Expression 36] instead of [Expression 34]).

### 6. Simulation and Experiment Results

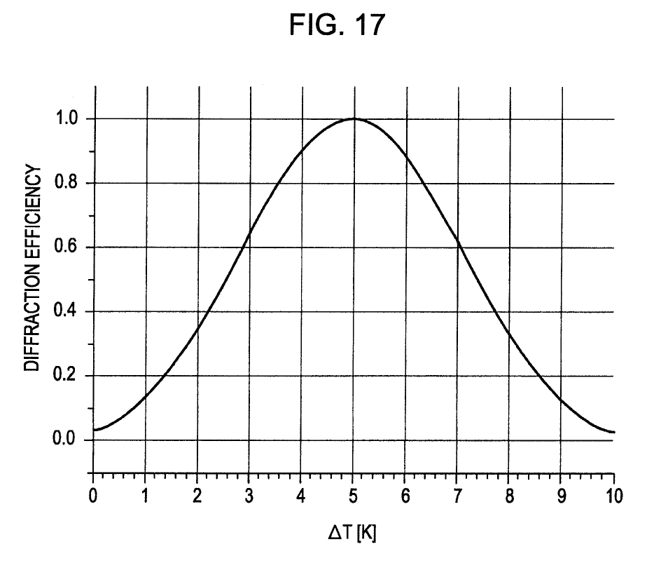

Next, FIG. 17 shows a calculation result regarding diffraction efficiency−temperature variation characteristic at the time of temperature compensation when the temperature variation ΔT is +5° C., by reference.

In addition, parameters used in obtaining the calculation result shown in FIG. 17 are as follows.
Recording wavelength λ_{W}=407 nm
Refractive index: n_{W}=1.50
Hologram effective thickness L₀=850 μm
Signal light NA: 0< sin θ_{sig}<0.30
Reference light NA: sin θ_{ref}=0.48
Coefficient of linear expansion:

C_{TEZ}=7.5*10⁻⁴K⁻¹

C_{TEX}=5.0*10⁻⁶K⁻¹
Temperature dependency v of refractive index: dn/dT=−2.5*10⁻⁴K⁻¹
Wavelength variation Δλ: −1.6 nm
Zoom power variation Δm: −0.004

The values of the zoom power variation Δm and wavelength variation Δλ are determined so that the diffraction efficiency can be improved to the maximum extent when ΔT is +5° C., by the method using [Expression 28] and [Expression 32] to [Expression 35]. According to the result shown in FIG. 17, it can be confirmed that the diffraction efficiency becomes the maximum when ΔT is +5° C. as intended. In this case, the diffraction efficiency is 1.0.

This calculation result also shows that the diffraction efficiency is appropriately improved by the temperature compensation method of the present embodiment.

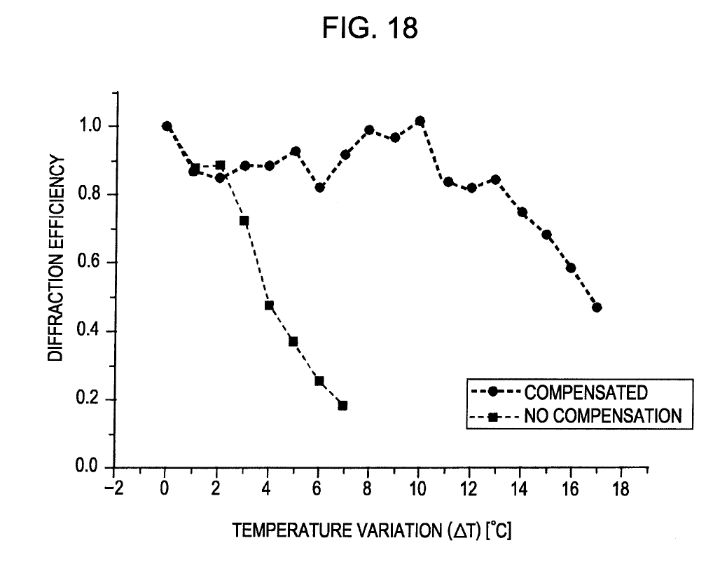

In addition, FIG. 18 shows experimental results regarding a change characteristic of the diffraction efficiency corresponding to a temperature change.

In FIG. 18, the horizontal axis indicates the temperature variation ΔT and the vertical axis indicates the diffraction efficiency (normalized diffraction efficiency), and a temperature−diffraction efficiency characteristic when there is temperature compensation of the present embodiment is shown by the plotting of black circles in the drawing. In addition, the plotting of black rectangles in FIG. 18 shows a temperature−diffraction efficiency characteristic when there is no temperature compensation for comparison.

For the case where there is temperature compensation, a characteristic in the range of the temperature variation ΔT of 0 to 17° C. is shown. Moreover, for the case where there is no temperature compensation, a characteristic in the range of the temperature variation ΔT of 0 to 7° C. is shown.

In addition, the conditions for obtaining the experimental result shown in FIG. 18 were as follows.
Recording medium: photopolymer (600 μm in thickness)
Recording wavelength λ_{W}=407 nm
Objective lens NA: 0.55.

Moreover, in this experiment, the temperature at the time of recording was 28.4° C. In addition, for the temperature compensation in this case, the wavelength variation Δλ and the zoom power variation Δm were made to change by −0.3 nm and −0.08, respectively, for every temperature rise of 1.0° C.

In FIG. 18, when there was no temperature compensation, the temperature range in which the diffraction efficiency could be maintained to 80% or more was a range up to ΔT=3.0° C. On the other hand, when the temperature compensation of the present embodiment was performed, the diffraction efficiency could be maintained to 80% or more up to the range of ΔT=13° C. From this experiment result, it can be understood that an improvement in the temperature tolerance of at least four or more times is realized by the temperature compensation of the present embodiment, compared with the related art in which the temperature compensation is not performed.

In addition, when the temperature compensation is performed, the diffraction efficiency is reduced to 80% or less in the range equal to or larger than ΔT=14° C. However, this does not indicate a limitation of the temperature compensation in this example, and this reduction in the diffraction efficiency is due to a chromatic aberration caused by the relay lens system (for example, 4, 6, 7, 8 in FIG. 1) or the objective lens 10 and the condensing lens 11. In other words, the temperature tolerance can be further improved by suppressing the chromatic aberration in these sections by lens design change, for example.

### 7. Specific Example of Temperature Compensation Processing in an Embodiment

Next, the processing that the recording/reproduction apparatus should perform in order to realize the above-described temperature compensation as the present embodiment will be described.

First, as described previously, it is assumed that values obtained by calculation or experiments are stored beforehand in the adjustment value table 16a, which is shown in FIG. 1 (FIG. 4), as the values of the zoom power variation (Δm) and wavelength variation (Δλ) which are to be set for every temperature variation (ΔT). As can also be understood from the previous explanation, the set of values of Δm and Δλ which are stored for every temperature variation ΔT satisfy the conditional expressions ([Expression 28] and [Expression 30]) for the prevention of image blur.

Under such an assumption, details of the temperature compensation processing as an embodiment that the control section 15 shown in FIG. 1 performs will now be described.

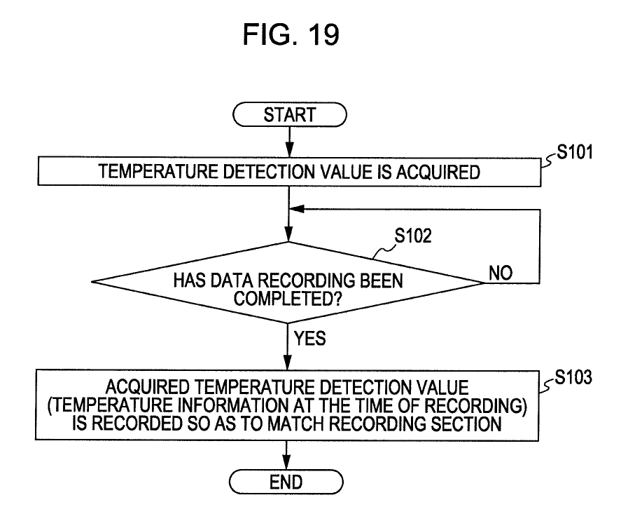

FIG. 19 is a flow chart showing the processing procedures that the control section 15 executes at the time of recording.

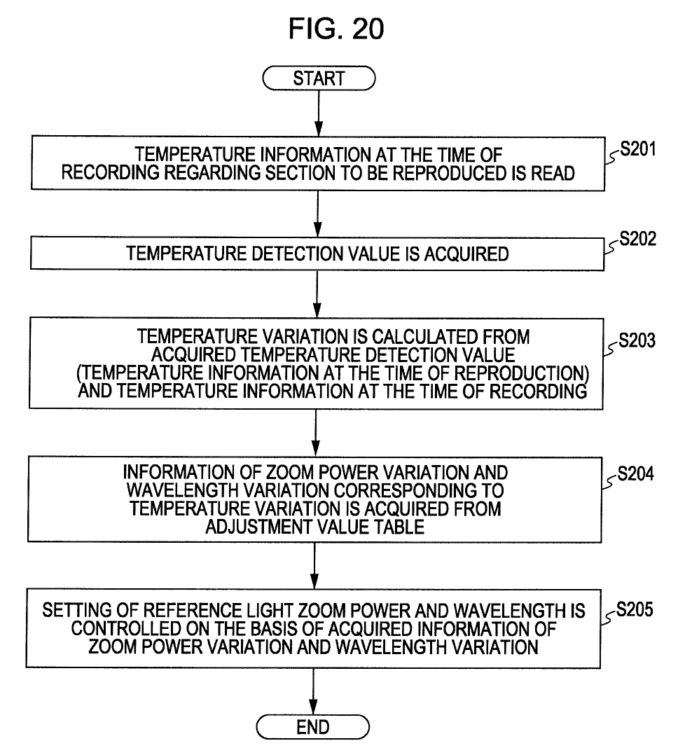

In addition, the control section 15 executes a processing operation (and a processing operation in FIG. 20 which will be described later) shown in FIG. 19 on the basis of a program stored in an internal ROM, for example.

Referring to FIG. 19, processing for acquiring the temperature detection value is first executed in step S101. That is, on the basis of a detection signal input from the temperature sensor 17 shown in FIG. 1, the temperature detection value indicating the temperature of the hologram recording medium HM is acquired.

Here, the processing of step S101 is processing for acquiring the temperature information on the hologram recording medium HM at the time of recording. The processing of step S101 may be performed simultaneously with the start timing of data recording on the hologram recording medium HM or may be performed at an arbitrary timing during data recording. It is preferable that the temperature acquisition processing of step S101 is performed at least between the start and end of data recording.

Then, in step S102, processing for waiting until the data recording ends is executed.

When the data recording ends, the process proceeds to step S103. In step S103, processing for recording the acquired temperature detection value (temperature information at the time of recording) so as to match a recording section is executed. That is, the modulation control section 13 is controlled such that the temperature information at the time of recording and the information of the recording section on the hologram recording medium HM, in which data recording has been performed by the current data recording processing (data recording processing confirmed to have ended in step S102), are recorded in the hologram recording medium HM so as to match each other. Specifically, the temperature information at the time of recording and the information of the recording section are given to the modulation control section 13, and the modulation control section 13 is instructed to execute a driving control to make the SLM 3 generate signal light for recording the temperature information at the time of recording and the information of the recording section in the hologram recording medium HM so as to match each other.

After the processing of step S103 is executed, the processing operation at the time of recording ends.

FIG. 20 is a flow chart showing the processing procedures that the control section 15 executes at the time of reproduction.

Referring to FIG. 20, processing for reading the temperature information at the time of the recording of a section to be reproduced is first executed in step S201.

Here, the temperature information at the time of recording is a kind of management information, such as TOC (Table Of Contents) information, instead of so-called user data. Generally, in the recording/reproduction apparatus for a recording medium, management information is read at the timing at which the recording medium is loaded and the management information is stored in a memory within the apparatus. In this case, the management information reading processing at the time of loading is equivalent to the reading processing of step S201.

Alternatively, it is also possible to adopt a method of reading the temperature information at the time of recording regarding the section, which is to be reproduced from the hologram recording medium HM, in a sequential manner at the time of the data reproduction of the desired section.

In any case, the control section 15 performs a control such that a reproduction operation on the predetermined section (section in which at least the temperature information at the time of recording is recorded) of the hologram recording medium HM is executed, and the temperature information at the time of recording is acquired by inputting the reproduced data obtained in the data reproducing section 14.

Then, in step S202, processing for acquiring the temperature detection value is executed. That is, the temperature detection value (that is, temperature information at the time of reproduction in this case) indicating the temperature of the hologram recording medium HM is acquired on the basis of the detection signal input from the temperature sensor 17.

Then, in step S203, processing for calculating the temperature variation (ΔT) from the acquired temperature detection value (temperature information at the time of reproduction) and temperature information at the time of recording is executed. The temperature variation ΔT indicates a temperature variation from the recording point of time when the reproduction is performed. Therefore, in step S203, the value of the temperature variation ΔT is calculated by performing calculation based on the “temperature at the time of recording −temperature at the time of reproduction”.

Next, in step S204, processing for acquiring the information on the zoom power variation (Δm) and the wavelength variation (Δλ), which corresponds to the temperature variation, from the adjustment value table is executed.

That is, the value of the zoom power variation and the value of the wavelength variation, which are stored so as to match the value of the temperature variation calculated in step S203, are acquired from the adjustment value table 16a.

In step S205, control for setting the reference light zoom power and the wavelength on the basis of the acquired information on the zoom power variation and the wavelength variation is performed.

That is, regarding the zoom power of reference light, the zoom power adjusting section 9 (lens driving section 9a) is controlled such that the movable lenses 7b and 8b are driven only in the direction and by the amount of driving corresponding to the zoom power variation acquired in step S204.

In addition, regarding the wavelength, the tunable laser 1 is controlled such that the wavelength of laser light is shifted by the wavelength variation acquired in step S204.

After the processing of step S205 is executed, the processing related to the temperature compensation of the embodiment ends.

In addition, as described above, the zoom power of reference light may also be adjusted by spatial light modulation of the SLM 3. In this case, the control section 15 instructs the modulation control section 13 to perform intensity modulation for the generation of the reference light in the SLM 3 according to the size of the reference light area A1 that is to be set up in response to the value of the zoom power variation acquired in step S204.

Alternatively, the zoom power adjustment of the reference light may also be performed using both the zoom power adjusting section 9 and spatial light modulation of the SLM 3. In this case, the control section 15 gives an instruction regarding the size of the reference light area A1 to the modulation control section 13 and an instruction regarding the amount of lens driving to the lens driving section 9a so that the zoom power of the reference light corresponding to the zoom power variation acquired in step S204 is set.

### 8. Conclusion

As described above, in the present embodiment, the occurrence of an image blur can be prevented by adjusting the zoom power and wavelength of reference light, which are to be adjusted in response to the temperature variation from the recording point of time when reproduction is performed, so as to satisfy the conditional expression presented in [Expression 28] or [Expression 30] when a method is adopted in which a reduction (and inequality) in diffraction efficiency caused by temperature change is compensated by adjustment of the zoom power and wavelength of the reference light. That is, according to a temperature compensation method such as the present embodiment, a reduction in diffraction efficiency caused by temperature change can be compensated for without generating an image blur in the reproduced image.

As a result, since the SN ratio can be improved in terms of both diffraction efficiency and the prevention of image blur, the SN ratio can be greatly improved compared with the case where the past temperature compensation method relating only to an improvement in diffraction efficiency is adopted.

Therefore, according to the present embodiment, the operable temperature range of the hologram recording/reproduction system can be enlarged.

In addition, in the present embodiment, the temperature information at the time of recording is recorded in the hologram recording medium HM so as to match the information of the recording section. When the reproduction is performed, the temperature information at the time of the recording of the section to be reproduced is acquired and the temperature variation is calculated on the basis of the temperature information at the time of recording.

Accordingly, the temperature compensation processing can be performed for every recording section. As a result, more exact temperature compensation can be realized, for example, compared with the case where the temperature compensation processing is performed for every recording section using the temperature information at the time of recording which is common to other recording sections.

### Second Embodiment

Next, a second embodiment will be described.

In the second embodiment, temperature compensation using a chromatic aberration lens is performed.

Now, it is assumed that there is an objective lens with a negative axial chromatic aberration, which satisfies [Expression 37] with an arbitrary focal distance f and wavelength λ.

(f+Δf)(λ_{W}+Δλ)=fλ_{W} [Expression 37]

By expanding and rearranging [Expression 37], [Expression 38] is derived.

$$1 + Δ m = 1 - \frac{Δ f}{f} = 1 + \frac{Δλ}{{λ}_{W}} \qquad [ Expression 38 ]$$

Here, it can be seen that [Expression 38] is equivalent to [Expression 30].

According to this, when an objective lens with an axial chromatic aberration based on [Expression 37] is used, the zoom power of reference light (incidence angle θ_{ref} of reference light) is corrected automatically with wavelength adjustment by the objective lens such that the relationship of [Expression 30] is satisfied. That is, by using the chromatic aberration objective lens which satisfies [Expression 37], temperature compensation for prevention of image blur can be realized similarly to the case of the first embodiment even if an adjustment mechanism, such as the zoom power adjusting section 9, is not provided.

Moreover, for clarity, [Expression 30] is a conditional expression satisfied on the assumption that a volume change of the recording layer L2 occurs only in the vertical direction as described above. That is, as can also be understood from this point, the second embodiment is realized on the assumption that the volume change of the recording layer L2 occurs only in the vertical direction.

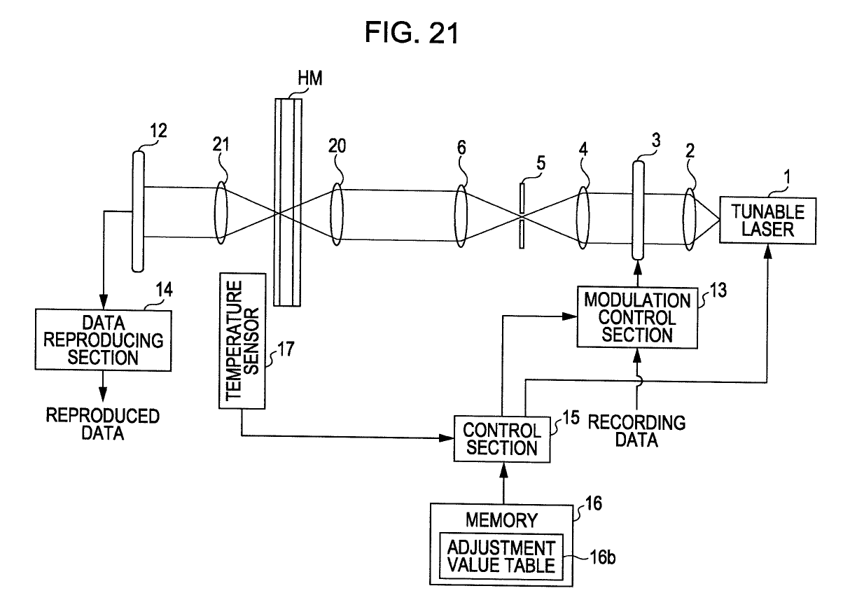

FIG. 21 is a block diagram showing the internal configuration of a recording/reproduction apparatus according to the second embodiment. Moreover, the same sections as in the recording/reproduction apparatus according to the first embodiment are denoted by the same reference numerals in FIG. 21, and explanation thereof will be omitted. Accordingly, only different points will be mainly described.

First, in the recording/reproduction apparatus according to the second embodiment, the zoom power adjusting section 9 provided in the recording/reproduction apparatus according to the first embodiment is not provided.

In addition, a chromatic aberration lens 20 may be provided instead of the objective lens 10, and a chromatic aberration lens 21 may be provided instead of the condensing lens 11.

As chromatic aberration lenses 20 and 21, lenses with negative axial chromatic aberrations which satisfy [Expression 37] are used.

Furthermore, in this case, an adjustment value table 16b is stored in the memory 16 instead of the adjustment value table 16a. In this case, as can also be understood from the previous explanation, it is preferable that an active adjustment operation in temperature compensation is performed for the wavelength. Accordingly, in the adjustment value table 16b, the value of wavelength variation to be set corresponding to the temperature variation is stored for every temperature variation.

In addition, as a method of determining the wavelength variation (Δλ) which is to be set for every temperature variation (ΔT) in order to improve and equalize the diffraction efficiency, it is preferable to adopt the same method as that described in the first embodiment (method using [Expression 32], [Expression 33], [Expression 36], and [Expression 35], or search based on an experiment). The value of wavelength variation for every temperature variation determined by such a determination method is stored in the adjustment value table 16b.

Also in the recording/reproduction apparatus according to the second embodiment, control processing for the temperature compensation operation is controlled by the control section 15.

Also in this case, the processing operation that the control section 15 executes at the time of recording is the same as that described in FIG. 19.

On the other hand, at the time of reproduction, the control section 15 in this case performs in common the processing of steps S201 to S203 shown in FIG. 20, but performs processing for acquiring only the information on the wavelength variation corresponding to the calculated temperature variation from the adjustment value table 16b in step S204. Then, in step S205, only wavelength setting control on the tunable laser 1 is performed on the basis of the acquired information on the wavelength variation.

According to the second embodiment, when the volume change of a recording material occurs only in the vertical direction, reduction and inequality in diffraction efficiency caused by temperature change can be compensated for without generating an image blur in the reproduced image. That is, also in the second embodiment, the SN ratio can be greatly improved compared with the case where a previous temperature compensation method is adopted. As a result, the operable temperature range of the hologram recording/reproduction system can be enlarged.

<Modifications>

While the embodiments of the present invention have been described, the present invention is not limited to the specific examples described previously.

For example, although the method of storing the values of the zoom power variation Δm and wavelength variation Δλ, which are to be set corresponding to the temperature variation, beforehand as the adjustment value tables 16a and 16b in the apparatus side was illustrated in the foregoing explanation, the values of the zoom power variation Δm and wavelength variation Δλ may be sequentially calculated by a function having the value of the temperature variation ΔT as a variable. That is, in this case, in the recording/reproduction apparatus, a function which is set such that the values of Δm and Δλ for the prevention of image blur and the improvement and equalization of diffraction efficiency are calculated using ΔT as a variable, for example, on the basis of [Expression 32] to [Expression 35] (or [Expression 36] instead of [Expression 34]) or [Expression 28] (or [Expression 29] and [Expression 30]) mentioned previously is stored beforehand as the above function in the memory 16 or the like. Moreover, at the time of reproduction in this case, the control section 15 calculates the values of Δm and Δλ sequentially on the basis of the calculated temperature variation ΔT and the function.

Since it is not necessary to store the adjustment value table when such a method is adopted, the memory capacity can be reduced accordingly.

Moreover, for clarity, when the method of storing the values of Δm and Δλ (or only Δλ) to be set beforehand like the adjustment value tables 16a and 16b is adopted, the load of calculation processing during adjustment can be reduced.

In addition, although the case where recording/reproduction was performed on the transmissive hologram recording medium HM and only a transmissive hologram was recorded in the hologram recording medium was illustrated in the explanation up to now, the present invention may also be appropriately applied to a case where a reflective hologram is recorded.

In the case of a reflective hologram (−π/2<θ_{sig}<π/2 and −π/2<θ_{ref}<3π/2), the sign in [Expression 32] changes to become [Expression 39].

$$Δ {k}_{Z} = - \frac{{k}_{W}}{{A}_{Z}} ( \begin{matrix}cos {θ}_{sig } + \\ cos {θ}_{ref}\end{matrix} ) + \frac{{k}_{W}}{{B}_{X}} ( \begin{matrix}\sqrt{{C}_{Δ n} - {B}_{X}^{2} {sin}^{2} {θ}_{sig}} + \\ \sqrt{{C}_{Δ n} - {B}_{X}^{2} {sin}^{2} {θ}_{ref }}\end{matrix} ) \qquad [ Expression 39 ]$$

In the case of a reflective hologram, it is preferable that the zoom power variation Δm (or the wavelength variation Δλ), which satisfies Δk_{Z}=0 (or satisfies the condition very close to Δk_{Z}=0), is calculated on the basis of [Expression 39].

Moreover, for clarity, in this case, only the method used when the optimal value of Δm (or Δλ) for the improvement and equalization of the diffraction efficiency is obtained by calculation is different. However, the point at which the relationship between Δm and Δλ which are to be set for every temperature variation ΔT satisfies the image blur prevention condition, such as [Expression 28] or [Expression 30], or the details of the temperature compensation processing are the same as those described previously.

In addition, the above explanation has been made on the assumption that the diffraction efficiency of the entire data page can be improved by setting one combination of zoom power variation Δm and wavelength variation Δλ. However, for example, when NA of an objective lens is relatively large and the volume change of a recording material is also relatively large, it is theoretically difficult to completely equalize the diffraction efficiency of the entire data page with one combination of zoom power variation Δm and wavelength variation Δλ.

In such a case, a method may be adopted in which one page is divided into a plurality of regions, reproduction is performed under the reproduction condition optimized in each region, and the reproduced data of each region are connected to restore the data of the entire page. As an extremely simple example, a method may be mentioned in which reproduction is performed twice, that is, reproduction based on the combination of zoom power variation Δm and wavelength variation Δλ for increasing the optical strength of a middle portion of a page and reproduction based on the combination of zoom power variation Δm and wavelength variation Δλ for increasing the optical strength of a peripheral portion of the page are performed for the reproduction of one hologram page and then the reproduced data are connected to obtain the reproduced data of the entire page.

In this case, it is a matter of course that the values of the zoom power variation Δm and wavelength variation Δλ set for the reproduction of each region are made to satisfy the image blur prevention condition presented previously so that the occurrence of an image blur is prevented.

Moreover, in the foregoing explanation, the case has been illustrated in which the control section 15 performs control for setting the zoom power and the wavelength on the basis of the information on the variation (Δm, Δλ) of zoom power or wavelength. However, undoubtedly, the control of setting the zoom power and the wavelength may also be performed on the basis of the zoom power m or the wavelength λ. In this case, in determining the values of m and λ to be set for the temperature compensation, it is preferable that Δm is replaced with m−1 and Δλ is replaced with λ−1 in each expression. In addition, the adjustment values stored in the adjustment value table 16a (or 16b) become the zoom power m and the wavelength λ.

In addition, although the case where the intensity modulation for generating signal light or reference light is performed using a transmissive liquid crystal panel has been illustrated in the foregoing explanation, the spatial light intensity modulation may also be performed using other configurations. For example, it is possible to adopt a configuration in which the intensity modulation is performed by the combination of a reflective liquid crystal device, such as an FLC (Ferroelectric Liquid Crystal), which performs polarizing direction control of incident light, and a polarization beam splitter or a configuration in which the intensity modulation is performed using a DMD (Digital Micromirror Device: registered trademark). The configuration of performing the intensity modulation for the generation of signal light and reference light is not limited to those illustrated in the embodiments.

In addition, although the case where the present invention is applied to the recording/reproduction apparatus capable of performing both recording and reproduction has been illustrated in the foregoing explanation, the present invention may also be appropriately applied to a reproduction-only apparatus (reproduction apparatus) which does not have a recording function.

The present application contains subject matter related to that disclosed in Japanese Priority Patent Application JP 2008-296570 filed in the Japan Patent Office on Nov. 20, 2008 and Japanese Priority Patent Application JP 2009-008845 filed in the Japan Patent Office on Jan. 19, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A reproduction apparatus comprising:
a wavelength-tunable light source that outputs light, which illuminates a hologram recording medium in which information is recorded by forming a hologram using interference fringes between signal light and reference light, such that a wavelength is variable;
an optical system that illuminates through an objective lens the hologram recording medium with the reference light generated on the basis of light emitted from the wavelength-tunable light source and that includes a power changing section which changes a zoom power of the reference light incident on the Objective lens;
a temperature detecting section that detects a temperature of the hologram recording medium; and
a control section that, when setting the zoom power of the reference light and the wavelength of the wavelength-tunable light source in response to a result of the temperature detected by the temperature detecting section, performs control such that the zoom power of the reference light and the wavelength of the wavelength-tunable light source satisfy a condition of
$$Δ m = \frac{Δ λ}{{λ}_{W}}$$
where, λ_{W} is a recording wavelength, Δm is a zoom power variation of the reference light from a recording point of time, and Δλ is a wavelength variation of the wavelength-tunable light source with respect to the recording wavelength.

2. The reproduction apparatus according to claim 1, further comprising a storage section that stores table information, in which combinations of adjustment values that satisfy the condition are stored as combinations of adjustment values for the zoom power and the wavelength which are set corresponding to a temperature variation of the hologram recording medium at the time of reproduction with respect to the temperature at the time of recording,
wherein information on the temperature of the hologram recording medium detected at the time of hologram recording is recorded, as temperature information at the time of recording, in the hologram recording medium, and
wherein the control section acquires adjustment values for the zoom power and the wavelength, which correspond to the temperature variation calculated from the table information, on the basis of the temperature information at the time of recording reproduced from the hologram recording medium and the temperature variation calculated from temperature information at the time of reproduction detected by the temperature detecting section and performs control for setting the power of the power changing section and control for setting the wavelength of the wavelength-tunable light source on the basis of the acquired adjustment values.

3. The reproduction apparatus according to claim 2,
wherein in the hologram recording medium, the temperature information at the time of recording is recorded for each recording section, and
wherein the control section calculates the temperature variation from temperature information at the time of recording regarding a reproduction section, which is reproduced from the hologram recording medium, and the temperature information at the time of reproduction detected by the temperature detecting section.

4. A reproduction method comprising the steps of:
detecting a temperature of a hologram recording medium in which information is recorded by forming a hologram using interference fringes between signal light and reference light; and
setting a zoom power and wavelength of the reference light, which satisfy a condition of
$$Δ m = \frac{Δ λ}{{λ}_{W}}$$
where, λ_{W} is a recording wavelength, Δm is a zoom power variation of the reference light from a recording point of time, and Δλ is a wavelength variation of the reference light with respect to the recording wavelength)], when setting the zoom power and wavelength of the reference light in response to a temperature detection result in the detecting of the temperature.

5. A reproduction apparatus comprising:
a wavelength-tunable light source that outputs light, which illuminates a hologram recording medium in which information is recorded by forming a hologram using interference fringes between signal light and reference light, such that a wavelength is variable;
an optical system that illuminates through an objective lens the hologram recording medium with the reference light generated on the basis of light emitted from the wavelength-tunable light source and that includes a power changing section which changes a zoom power of the reference light incident on the objective lens;
a temperature detecting section that detects a temperature of the hologram recording medium; and
a control section that, when setting the zoom power of the reference light and the wavelength of the wavelength-tunable light source in response to a result of the temperature detected by the temperature detecting section, performs control such that the zoom power of the reference light and the wavelength of the wavelength-tunable light source satisfy a condition of
$$1 + Δ m = \frac{1}{( 1 + {C}_{TEX} Δ T + {σ}_{X} )} ( 1 + \frac{Δ λ}{{λ}_{W}} )$$
where, λ_{W} is a recording wavelength, Δm is a zoom power variation of the reference light from a recording point of time, Δλ is a wavelength variation of the wavelength-tunable light source with respect to the recording wavelength, σ_{X} is a recording material contraction rate in an in-recording-surface direction according to the polymerization of a monomer of a recording material of the hologram recording medium, C_{TEX} is a coefficient of linear expansion of the recording material, and ΔT is a temperature variation from a recording point of time.

6. A reproduction method comprising the steps of:
detecting a temperature of a hologram recording medium in which information is recorded by forming a hologram using interference fringes between signal light and reference light; and
setting a zoom power and wavelength of the reference light, which satisfy a condition of
$$1 + Δ m = \frac{1}{( 1 + {C}_{TEX} Δ T + {σ}_{X} )} ( 1 + \frac{Δ λ}{{λ}_{W}} )$$
where, λ_{W} is a recording wavelength, Δm is a zoom power variation of the reference light from a recording point of time, Δλ is a wavelength variation of the reference light with respect to the recording wavelength, σ_{X} is a recording material contraction rate in an in-recording-surface direction according to the polymerization of a monomer of a recording material of the hologram recording medium, C_{TEX} is a coefficient of linear expansion of the recording material, and ΔT is a temperature variation from a recording point of time)], when setting the zoom power and wavelength of the reference light in response to a temperature detection result in the detecting of the temperature.

7. A reproduction apparatus comprising:
a wavelength-tunable light source that outputs light, which illuminates a hologram recording medium in which information is recorded by forming a hologram using interference fringes between signal light and reference light, such that a wavelength is variable;
an optical system that illuminates through an objective lens the hologram recording medium with the reference light generated on the basis of light emitted from the wavelength-tunable light source, the objective lens being a chromatic aberration lens with an axial chromatic aberration which satisfies
(f+Δf)(λ_{W}+Δλ)=fλ_{W}
where, λ_{W} is a recording wavelength, Δλ is a wavelength variation of the wavelength-tunable light source with respect to the recording wavelength, f is a focal distance of the objective lens, and Δf is a variation of the focal distance in response to the wavelength variation;
a temperature detecting section that detects a temperature of the hologram recording medium; and
a control section that performs control for setting the wavelength of the wavelength-tunable light source in response to a result of the temperature detected by the temperature detecting section.
